(19) United States
(12) Patent Application Publication
(10) Pub. No.: US 2012/0303342 A1
(43) Pub. Date: Nov. 29, 2012

(54) METHOD AND SYSTEM FOR REPRESENTING WELLS IN MODELING A PHYSICAL FLUID RESERVOIR

(76) Inventors: RANDY DOYLE HAZLETT, Dallas, TX (US); Desarazu Krishna Babu, Spring, TX (US)

(21) Appl. No.: 13/560,996

(22) Filed: Jul. 28, 2012

Related U.S. Application Data
(63) Continuation-in-part of application No. 12/436,779, filed on May 7, 2009.

(51) Int. Cl. G06F 17/13

(52) U.S. Cl. 703/2

(57) ABSTRACT

The disclosure is directed to a method of representing fluid flow response to imposed conditions in a physical fluid reservoir through wells. The invention utilizes techniques and formulas of unprecedented accuracy and speed for computer computation of Green's and Neumann functions in finite three-dimensional space for arbitrarily-oriented line sources in anisotropic media. The method includes the modeling of fluid flow in physical fluid reservoirs with an assemblage of linear well segments, characterizing arbitrary well trajectory, operating in unison with flux density coupled to flow rate within the well through a constitutive expression linking pressure distribution and flow. The method further includes generalization to complex fracture sets or fractured wells in modeling fluid flow in a reservoir, coupled use of such computations within a mesh representation of the physical fluid reservoir with isolation of well cell contributions, and extension to modeling of heterogeneous reservoirs and pressure transients.

### REFERENCE TO RELATED APPLICATIONS

This application is a continuation-in-part (CIP) to previous application Ser. No. 12/436,779, filed May 7, 2009 by inventors Randy Doyle Hazlett and Desarazu Krishna Babu.

### ACKNOWLEDGMENT OF GOVERNMENT SUPPORT

Not Applicable

### COMPACT DISC APPENDIX

Not Applicable

### BACKGROUND OF THE INVENTION

1. Field of the Invention

The invention pertains to the field of oil and gas well productivity modeling, and more particularly, to modeling the relationship between pressure gradient and fluid flux for the well and the surrounding hydrocarbon reservoir. More specifically, the invention relates to well productivity modeling for advanced well designs and to well connections for complex wells in numerical reservoir simulation methods.

2. Description of Related Art

The field of reservoir engineering includes modeling the capacity of wells to inject or withdraw fluids and the sustainability of production rates. The finite size and shape of hydrocarbon reservoirs dictates the long term relationship between withdrawal rate and pressure decline. Well equations try to capture this relationship for the dominant time period of well operation, known as the pseudo-steady state regime, as a function of reservoir characteristics and well properties, such as well radius and well location. Well equations are traditionally constructed for single phase flow and suitably modified through introduction of empirical relative permeability concepts for multiphase flow use. With adequate well models, numerical reservoir simulation is used to place wells optimally (U.S. Pat. No. 7,181,380).

Early use of well equations was based upon mathematical solutions to the governing equations, but these were amenable for only the simplest of reservoir descriptions and well configurations. The industry turned to numerical methods and computers to solve the governing equations with more complex inputs. Examples of such simulation methods are found in U.S. Pat. No. 7,369,973, U.S. Pat. No. 7,324,929, U.S. Pat. No. 6,810,370, and U.S. Pat. No. 7,289,942. However, the physical size of a wellbore, nominally 6 inches, is far below the resolution of most numerical reservoir simulations. As such, the industry relies upon so-called well equations to relate the properties of a reservoir grid cell to observables, i.e. pressure and flow rate, for a well within the cell. Well equations, pioneered by Peaceman (1978), were constructed from fine scale numerical simulations for use at the practical scale, and as such, entertained only a small subset of possible configurations. In order to capture smaller scale effects, some practitioners use local grid refinement around wells (U.S. Pat. No. 6,907,392, U.S. Pat. No. 7,047,165, U.S. Pat. No. 7,451,066, U.S. Pat. No. 6,078,869, U.S. Pat. No. 6,018,497), dramatically increasing the computational overhead with greater risk of problem numerical instability.

The application of horizontal drilling technology made the prior set of well equation rules obsolete, as hydrocarbon reservoirs are typically laterally extensive but thin. The proximity of reservoir boundaries in horizontal wells required new relationships. The industry returned to mathematical solutions of the governing equations to redefine well equations. While breakthroughs in modeling were found, this next generation of mathematical solutions was not without limitations regarding complexity of reservoir description and allowed well configurations. Some developments restricted the solution to the case where the well was aligned with a coordinate axis (Babu and Odeh, 1989). Such solutions applied to purely horizontal or vertical wells, and not the general slanted well of arbitrary inclination. Slanted wells were approximated by stair-step assembly of horizontal and vertical segments or by restricting well orientation (Jasti, Penmatcha, and Babu, 1997). Alternatively, Aavatsmark and Klausen (2003) use a coordinate transform for slanted and slightly curved wells.

These equations also applied to the reservoir as a whole and could be localized for use in simulations only for uniform numerical grids in a homogeneous reservoir (Babu et al., 1991). Furthermore, the computational time is a substantial burden in numerical schemes for certain sets of input parameters. As mathematical solutions to differential equations, the models are specific to boundary conditions imposed at the physical limits to the reservoir. The boundary condition most often imposed is that of a sealed system; however, many reservoirs have leaky sides through which the influx of water is possible, resulting in delayed pressure decline. Older models exist for so-called bottom and edge water drive mechanisms; there remains a need to account for these options in advanced models. The industry typically defers to numerical simulation methods to incorporate these effects locally rather than globally. The restriction of analytic solutions to homogeneous systems has been somewhat overcome through the use of boundary integral methods to solve for pressure in a piece-wise homogeneous fashion (Hazlett and Babu, 2005). Still, prior art using semi-analytical solutions did not entirely replace the older Peaceman-type methods using empirical well connections.

The concept of skin was introduced in modeling permeability alteration around wells resulting from stimulation or formation damage. Similar to well equations, skin represents an attempt to describe behavior without an explicit representation of the modified permeability feature or zone. A fractured well has a different fluid capture geometry than an unstimulated well. With increased industry activity in unconventional reservoirs invoking multiple hydraulic fracturing stages, there is further need for new models with enhanced capabilities. In addition to complex geometry in hydraulically fractured shale, early transient behavior dominates economic forecasts, and pseudo-steady state may never be attained. Microseismic mapping technology is yielding tremendous insight into the complex fracture patterns created (Mayerhofer et al., 2010; Fisher et al., 2004). While simpler models have gained attention, state-of-the-art numerical reservoir modeling (Cipolla et al., 2010; Mayerhofer et al., 2006) involves extensive adaptive gridding around discrete fracture patterns with cells approaching dimensions of actual fracture apertures. Such models require considerable computational resources and extensive inputs not generally amenable to field measurement or laboratory verification.

A three-dimensional solution that honors the closed system boundary condition has been long recognized (Carslaw and Jaeger, 1959). However, these solutions, when applied to box-shaped rectangular domains, become computationally challenging. Of note, Durlofsky (2000, 2004) correctly writes the solution for one-dimensional, time-dependent potential for a point source in a closed system as unity plus an infinite sum of two cosine product terms with a third exponentially-damped factor in time. These authors then invoke Neumann's product rule to cast the solution in three dimensions as the product of three one-dimensional solutions. While this is indeed a statement of the problem solution, it has not been cast in a readily computable form. In particular, the triple infinite series contains mathematical singularities, converges very slowly, and becomes increasingly difficult to evaluate as the observation point, (x, y, z) approaches the location of the point source, (xₒ, yₒ, zₒ). Unfortunately, the observation point of most interest is one extremely nearby corresponding to the wellbore radius. What is needed is a fast and accurate method to evaluate this known raw solution.

The point source solution is not the solution most closely aligned with wells. Rather, we are interested in line sources in three-dimensional space. The line source can be cast as the integration of the point source solution along a trajectory. A number of researchers have posed the problem in this manner for application to horizontal (Economides et al., 1996) and non-conventional wells (Maizeret, 1996; Ouyang et al., 1997; Wolfsteiner et al., 1999, 2003; Durlofsky, 2004), where the term non-conventional implies wells at arbitrary angle or varied trajectory. All these approaches leverage the work of Economides et al. (1996) in which the authors elaborate upon the published efforts of others seeking direct analytical formulas, “The above works are outstanding contributions, presenting closed-form expressions and must be considered seminal work. We believe, though, that analytical approaches have reached their limitations.” In Appendix A, Economides et al. (1996, 261) reveal their approach to abandon the search for closed-form expressions and “ . . . integrate the solution for the point source numerically along the well trajectory.” The authors included a couple of cautionary notes. First, this approach “relies strongly on the ability to compute this point source solution accurately and fast.” Secondly, a term containing a singularity is substracted from the numerically evaluated integrand in order to remove much of the “spiked” character of the function being integrated. Maizeret (1996) followed a similar route in constructing solutions using numerical quadrature rather than seeking direct solutions of closed form. In Figure A.1 (p. 43), Maizeret plots the original function to be numerically integrated along with the modified function recommended to handle numerical problems due to the proximity to a mathematical singularity. Remarkably, both functions remain markedly spiked in nature, disclosing that challenges still remain in numerical evaluation, especially with quadrature methods built upon smooth polynomial approximation to functions. In Section B-2 (p. 50) on modifications needed, Maizeret cautions, “The objective is to increase the speed of the program which in its present state can be fairly slow for some cases.” Ouyang et al. (1997), Wolfsteiner et al. (1999, 2003), and Durlofsky (2004) all follow the Economides/Maizeret approximate numerical solution method. While Durlofsky (2004) does not give procedural detail before proceeding to cite further developments and applications for unconventional wells, methodology relying on numerical integration approximation is clear in companion documents (Ouyang & Aziz, 2001; Wolfsteiner et al., 1999; Maizeret, 1996). What is needed is a method that avoids approximation in integration, accounts fully for the singular nature of functions encountered, and produces direct, closed-form analytical expressions for the fast and accurate evaluation of pressure, especially where the observation point corresponds to the wellbore radius when numerical integration methods are most challenged.

A number of researchers have demonstrated approaches to couple the representative pressure of well segments in a multi-segment well representation to the flow within the wellbore (Ouyang & Aziz, 2001; Durlofsky, 2004; Wolfsteiner et al., 1999). Thus, the pressure gradient along the well trajectory that pulls in fluid from the reservoir also satisfies approximations to physical laws for incoming fluid to flow within the well to a common collection point. What is needed is a computer method to couple the pressure drop due to fluid flow within a wellbore to a faster and more accurate computational method for well inflow distribution in complex wells.

While the pseudo-steady state flow regime, in which average pressure continues to change but spatial gradients in pressure are constant, is the dominant period associated with the production life of a conventional well, and thus, is used in well equations, there is a need to compute production as a function of time, including early transients. Use of transient information provides the basis for so-called well testing to evaluate reservoir characteristics. Since singularities in the governing equations occur in terms of space, incorporation of temporal effects represents no new mathematical challenges to those in the field skilled in the art. Though not explicitly stated, but as is evident in related works, Durlofsky (2004) performed integrations in time with numerical approximation. In their analytic solution formulations, Odeh and Babu (1990) incorporated time and described the various time regimes possible leading up to pseudo-steady state production for strictly horizontal wells. What is needed is a temporal representation of production from wells of arbitrary trajectory in which inflow is computed from highly accurate direct formulas and rapidly convergent series produced by exact integrations in time and space using antiderivatives consistent with the Fundamental Theorem of Calculus and further simplification using mathematical identities for enhanced computational efficiency.

There is a need for simple analytic productivity equations which can model the entire reservoir for different combinations of boundary conditions. It would be highly desirable to have a well productivity model which could quickly and accurately model pressure and flow rate for an arbitrary number of wells of arbitrary trajectory or of complex, multiple wellbore configuration for various imposed reservoir boundary conditions.

There is further need to embed a fast-computing, accurate well equation that is capable of modeling wells of arbitrary trajectory or complex, multiple wellbore configurations below the resolution of the simulation in a numerical reservoir simulator. It would be highly desirable to have such a well productivity model that could restrict attention locally to the cell containing the well without loss of generality or accuracy and that could also be used within a feedback loop to restrict well pressure or production.

### SUMMARY OF THE INVENTION

The invention comprises the reduction of a generalized equation describing the productivity of an arbitrarily-oriented well segment within a subterranean fluid reservoir to a readily useable form of evaluation with unprecedented accuracy, consisting of a sum of direct, analytic formulas and fast-converging, exponentially-damped series summations, and subsequent use of this new method on a computer to accomplish new tasks, such as, but not limited to, productivity modeling of wells of arbitrary trajectory, including those with multiple intersecting wellbores. The invention also encompasses the interlacing of a new well equation in numerical reservoir simulators with wells below the resolution of the grid system used to define the reservoir size, shape, and heterogeneous property distribution and the use of such equations for feedback control on flux or well pressure within the simulator. The invention is capable of accurately modeling multiple wells simultaneously with sealed boundaries or with permeable boundaries through use of boundary integral equations. The invention is robust and adaptable to well constraints on either flux or pressure, allowing coupling to constitutive relations for fluid flow within the well. The invention applies also to two-dimensional simulation in thin reservoirs where horizontal and slanted wellbores behave as vertical, fully penetrating fractures with the orientation of their projections onto the XY plane. The invention further applies to production modeling from two-dimensional, complex discrete fracture sets induced in unconventional reservoirs for hydrocarbon production. The invention represents an unprecedented level of accuracy and flexibility in modeling wells with significant time savings over prior art due to a reduction of the solution to polynomial expressions and rapidly convergent infinite series summations. This is accomplished with exact integrations in time and space using antiderivatives according to the Fundamental Theorem of Calculus and subsequent simplification using mathematical identities. The invention replaces computationally burdensome and inaccurate prior art numerical approximations for temporal and spatial integration of the point source solution containing singularities to represent nonconventional wells.

### BRIEF DESCRIPTION OF THE DRAWINGS

FIG. 1 shows a schematic of a line source inside a three-dimensional box of dimensions a, b, and h with endpoints (x₁, y₁, z₁) and (x₂, y₂, z₂), length, L, and direction cosines (α,β, γ).

FIG. 2 shows the dimensionless pressure distribution,

$$\tilde{P} ( x , y , z ) ≡ \frac{( P ( x , y , z ) - \overline{P} ) abh}{4 π B μ q} ,$$

within a unit cube of isotropic permeability for an XZ slice containing a well represented by a uniform flux line source with well endpoints (x₁, y₁, z₁)=(0.25, 0.50, 0.25) and (x₂, y₂, z₂)=(0.75, 0.50, 0.75): (a) Partially penetrating well configuration, and (b) Pressure distribution for the XZ plane containing the well shown with a banded look-up table in order to easily visualize isopotential contours.

FIG. 3 shows validation of the time-dependent dimensionless well pressure as a function of dimensionless time for two partially-penetrating, horizontal wells centered in a square drainage area. Solid lines represent the results of Economides et al. (1996), while data points come from the described invention with an observation point 70% of the distance from midpoint to tip. The computations are for wells parallel to the x-axis with normalized length ratios, L/a, of 0.2 and 0.8, respectively, a square drainage area, a thickness ratio, h/a, of 0.05, an isotropic medium, and a well radius, r_{w}/a, of 0.0004.

FIG. 4 shows validation of the time-dependent dimensionless well drawdown pressure as a function of dimensionless time for variable length, partially-penetrating, uniform flux fractures centered in a square drainage area. Solid lines represent the results of Gringarten et al. (1974), while data points come from the two-dimensional subset of the described invention with midpoint observation selection.

FIG. 5 shows dimensionless pressure maps of P(x,y)−P_{avg} for time-dependent discrete well modeling of fracture patterns interpreted from microseismic (Mayerhofer et al., 2006) in the stimulation of a vertical Barnett well. Production is modeled on a 3500 ft square with a uniform fracture pressure assumption. The grayscale for each image is self-normalized with maximum and minimum values for optimal viewing. a) t_{D}=0.0001, b) t_{D}=0.001, c) t_{D}=0.01, and d) t_{D}=0.1.

FIG. 6 shows dimensionless stimulated well productivity as a function of dimensionless time for the fracture set interpreted from microseismic mapping by Mayerhofer et al. (2006) during single stage stimulation of a vertical Barnett well. Inset is the digitized fracture mapping used in the infinite conductivity fracture superposition model.

FIG. 7 shows dimensionless pressure maps of P(x,y)−P_{avg} for time-dependent discrete well modeling of fracture patterns interpreted from microseismic (Fisher et al., 2004) in the multistage stimulation of a horizontal Barnett well. Production is modeled on a 6000 ft square with a uniform fracture pressure assumption. The grayscale for each image is self-normalized with maximum and minimum values for optimal viewing. a) t_{D}=0.0001, b) t_{D}=0.001, c) t_{D}=0.01, and d) t_{D}=0.1.

FIG. 8 shows dimensionless stimulated well productivity for infinite conductivity and uniform flux fractures as a function of dimensionless time for the fracture set interpreted from microseismic mapping by Fisher et al. (2004) during multistage stimulation of a horizontal Barnett well. Inset is the digitized fracture mapping used in the infinite conductivity fracture superposition model.

FIG. 9 shows a line source from (x₁, y₁, z₁) to (x₂, y₂, z₂) indicating the midpoint where the well pressure is typically evaluated along the locus of points on the plane normal to the well axis at a physical distance r_{w}, the well radius, from the mathematical source.

FIG. 10 shows an example of pressure computation for a well configuration within a unit cube leading to nonsymmetric isopotential surfaces normal to the well: (a) Partially penetrating well configuration, and (b) Pressure distribution for the XZ plane normal to the well at the midpoint, (c) Pressure distribution for the YZ plane containing the well, and (d) A close-up view of the pressure distribution in the immediate vicinity of the mathematical line source indicating a loss of symmetry as a function of radius and variation in pressure at the well radius, r_{w}, as a function of position using r_{w}/a=0.015.

FIG. 11 shows XY planar slices of dimensionless pressure at different elevations through a cubic cell of homogeneous permeability in which a multilateral well with a motherbore and four laterals in the configuration shown in the schematic, demonstrating the capability of modeling advanced wells. In this example, the flux per unit of well length is held constant.

FIG. 12 shows a multi-segmented well illustrating the construction of differential pressure constraints along the length of a well and relationships imposed. Each segment is

characterized by the pressure at the midpoint at the well radius and an average flux in this piecewise uniform flux model. The internal flow rate increases progressively, starting from the tip in a production well, while the pressure drop between segments is a function of the Reynolds Number, N_{Re}, and a wall roughness parameter.

FIG. 13 shows the pressure distribution resulting from production through an advanced well forming a curved pathway within a homogeneous, 3D, cubic medium in which the well is composed of 29 adjoining, piecewise linear segments with either constant flux or constant pressure imposed at a chosen well radius (r_{w}/a=0.00015) at the segment midpoints and graphs depicting the flux and pressure at those locations as a function of progressive length down the well: (a) Well configuration within the cell, (b) Central XZ slice through the computed pressure field for the plane containing the well with imposed uniform flux, (c) Central XZ slice through the computed pressure field for the plane containing the well with imposed uniform pressure, (d) Plot of pressure and flux as a function of cumulative well length for the uniform flux case, and (e) Plot of pressure and flux as a function of cumulative well length for the uniform pressure case.

FIG. 14 shows a rectangular cell containing a line source representing a well from (x₁, y₁, z₁) to (x₂, y₂, z₂), an observation point, which is typically a location at the reservoir sandface, and the six external faces upon which a single value of flux is ascribed. Note the z values increase downward in accordance with industry standards, and all outward normal fluxes are defined as positive, as conventional in mathematics.

FIG. 15 shows three-dimensional plots of pressure for the same curvilinear well trajectory as in the constant pressure case of FIG. 13 with various combinations of open and closed boundaries: (a) the sealed boundary case in which the medium behaves as a volume-distributed source, supplying fluid to the well through fluid expansion as the average cell pressure declines, (b) the case with uniform flux on two lateral faces, each supplying half the well production, and (c) the case with uniform flux from the bottom face supplying the full well production. The choice of banded lookup table allows easy visualization of isopotential surfaces. Note that isopotential surfaces intersect sealed boundaries at right angles. The flux density weighted average pressure at a prescribed well radius is given as an annotation, indicating sensitivity of well observations to external boundary conditions.

### DETAILED DESCRIPTION OF THE INVENTION

The invention pertains to solutions to the three-dimensional heat equation, given in a Cartesian coordinate system in terms of potential, Φ, as

$${k}_{x} \frac{{\partial }^{2} Φ}{\partial {x}^{2}} + {k}_{y} \frac{{\partial }^{2} Φ}{\partial {y}^{2}} + {k}_{z} \frac{{\partial }^{2} Φ}{\partial {z}^{2}} = φμ {C}_{t} \frac{\partial Φ}{\partial t} - f ( x , y , z ; {x}_{o} , {y}_{o} , {z}_{o} ) . \qquad ( 1 )$$

Here, (kₓ, k_{y}, k_{z}) denote the directional permeabilities of the medium through which fluid moves, Φ, μ, and Cₜ represent the porosity, fluid viscosity, and system compressibility, respectively, and the last term indicates a source or sink. Potential is interpreted as pressure, P, once gravitational forces are included. In terms of the Dirac delta function, δ, a RHS point source term is represented as

f(x,y,z;xₒ,yₒ,zₒ)˜δ(x−xₒ)·δ(y−yₒ)·δ(z−zₒ). (2)

Using the two solutions given by Carslaw and Jaeger (1959) to the one-dimensional heat equation and the Neumann product rule, we have alternate expressions for the three-dimensional statement of the solution. One computes the departure from initial conditions as

$${P}_{D C} = \frac{abh}{8 \sqrt{{π}^{3} {k}_{x} {k}_{y} {k}_{z}}} \cdot {\int }_{0}^{{\hat{t}}_{D}} \frac{d t}{{t}^{3 / 2}} \cdot [ {\sum }_{l = 0}^{∞} {e}^{- \frac{{( 2 la \pm x \pm {x}_{o} )}^{2}}{4 {k}_{x} t}} ] \cdot [ {\sum }_{m = 0}^{∞} {e}^{- \frac{{( 2 mb \pm y \pm {y}_{o} )}^{2}}{4 {k}_{y} t}} ] \cdot [ {\sum }_{n = 0}^{∞} {e}^{- \frac{{( 2 nh \pm z \pm {z}_{o} )}^{2}}{4 {k}_{z} t}} ] , \qquad ( 3 )$$

where we introduce the dimensionless pressure due to a continuous point source, P_{DC}, and dimensionless time, \hat{t}_{D}.

$${P}_{D C} ≡ \frac{{P}_{i} - P ( x , y , z ; … ; t )}{qB μ / V} ≡ \frac{V \cdot Δ P}{qB μ} ; {\hat{t}}_{D} ≡ \frac{t}{φ μ {C}_{t}} \qquad ( 4 )$$

This dimensionless time is related to a more common lumping with a second dimensionless scaling group, k/xₑ², such that t_{D}≡\hat{t}_{D}·(k/xₑ²), where xₑ is a characteristic length scale we choose to represent with the longest box dimension, a. Other variants of the dimensionless time use area in place of a² for nonsquare domains. A second form of the same continuous point source solution is rooted in the method of images and catalogs the approach to pseudo-steady state.

$${P}_{D C} = {\int }_{0}^{{\hat{t}}_{D}} d t \cdot [ 1 + 2 {\sum }_{l = 1}^{∞} {e}^{- \frac{{π}^{2} {l}^{2} {k}_{x} t}{{a}^{2}}} \cdot cos ( \frac{π lx}{a} ) cos ( \frac{π {lx}_{o}}{a} ) ] \cdot [ 1 + 2 {\sum }_{m = 1}^{∞} {e}^{- \frac{{π}^{2} {m}^{2} {k}_{y} t}{{b}^{2}}} \cdot cos ( \frac{π my}{b} ) cos ( \frac{π {my}_{o}}{b} ) ] \cdot [ 1 + 2 {\sum }_{n = 1}^{∞} {e}^{- \frac{{π}^{2} {n}^{2} {k}_{z} t}{{h}^{2}}} \cdot cos ( \frac{π nz}{h} ) cos ( \frac{π {nz}_{o}}{h} ) ] \qquad ( 5 )$$

It is recognized that evaluation of Eq. 3 is more tractable for short times, while the exponential damping in time in Eq. 5 aids in evaluating transients at longer times. In either case, evaluation of the time independent contribution is problematic due to the presence of spatial singularities, leading to extremely slow convergence.

While others have opted for integration using numerical schemes despite problems cited in evaluation of the integrand, the invention pertains to exact integration in both time and space. The Fundamental Theorem of Calculus links the processes of differentiation and integration. In particular, it allows exact integration with identification of an appropriate antiderivative. This invention identifies and incorporates such antiderivatives. As such, the singular nature of the integrand is handled without approximation or error.

In particular, this invention pertains to a fast method to compute the solution for a line source term representing a well with arbitrary three-dimensional orientation within a sealed, rectangular, box-shaped cell.

$${P}_{D} ≡ \frac{1}{L} \cdot {\int }_{0}^{L} {P}_{D C} \cdot d s \qquad ( 6 )$$

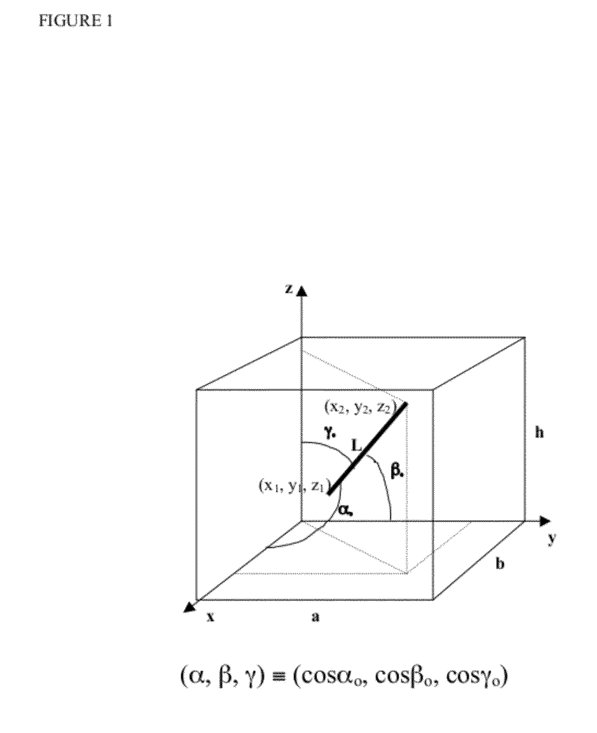

Such spatial integration can be carried out on either Equation (3) or Equation (5). The source is represented by a straight line of length L, with endpoints (x₁, y₁, z₁) and (x₂, x₂, y₂), located within the box as illustrated in FIG. 1. Let the direction cosines of this line be (α, β, γ), so that (Lα, Lβ, Lγ)≡[(x₂−x₁),(y₂−y₁),(z₂−z₁)]. Points on this line source are represented parametrically,

(xₒ,yₒ,zₒ)≡[(x₁+αs),(y₁+βs),(z₁+γs)],0≦s≦L, (7)

where the parameter “s” measures the distance along its length from one end.

Concentrating on the more problematic approach to pseudo-steady state given by Equation (5), integration with respect to time using antiderivatives yields

$${P}_{D} ( x , y , z ; {x}_{1} , {y}_{1} , {z}_{1} ; α , β , γ ; L , t ) ≡ ( \frac{t}{φ μ {C}_{t}} ) + \frac{1}{L} \cdot {\int }_{0}^{L} {\sum }_{l , m , n \neq 0}^{∞} \frac{{C}_{lmn}}{{π}^{2}} \frac{\cdot ( trig )}{{D}_{lmn}^{2}} d s - \frac{1}{L} \cdot {\int }_{0}^{L} {\sum }_{l , m , n \neq 0}^{∞} \frac{{C}_{lmn}}{{π}^{2}} \frac{E \cdot ( trig )}{{D}_{lmn}^{2}} d s , \\ where \\ E ≡ exp ( \frac{- {π}^{2} {D}_{lmn}^{2} t}{φ μ {C}_{t}} ) ; \\ {D}_{lmn}^{2} ≡ ( \frac{{k}_{x} {l}^{2}}{{a}^{2}} + \frac{{k}_{y} {m}^{2}}{{b}^{2}} + \frac{{k}_{z} {n}^{2}}{{h}^{2}} ) ; \\ trig ≡ cos ( \frac{π lx}{a} ) cos ( \frac{π my}{b} ) cos ( \frac{π nz}{h} ) cos ( \frac{π {lx}_{o}}{a} ) cos ( \frac{π {my}_{o}}{b} ) cos ( \frac{π {nz}_{o}}{h} ) \qquad ( 8 )$$

The factor, Cₗₘₙ, takes on values 2, 4, and 8, depending upon the dimensionality of the infinite series. On the RHS of Equation (8), the part containing the first two terms is identified as the PSS component of the dimensionless pressure drop, P_{D}. The remaining term is the transient component of the pressure that vanishes in long time behavior.

Focusing on the transient term, spatial integration using antiderivatives gives

$${P}_{trans} = \frac{1}{2 {π}^{3}} {\sum }_{l , m , n \neq 0}^{∞} \frac{{C}_{lmn} exp ( - {π}^{2} {D}_{lmn}^{2} {\hat{t}}_{D} ) \cdot cos ( \frac{π lx}{a} ) cos ( \frac{π my}{b} ) cos ( \frac{π nz}{h} )}{( \frac{{k}_{x} {l}^{2}}{{a}^{2}} + \frac{{k}_{y} {m}^{2}}{{b}^{2}} + \frac{{k}_{z} {n}^{2}}{{h}^{2}} )} \cdot λ ( {{x}^{->}}_{1} , {{x}^{->}}_{2} , l , m , n , a , b , h ) , \qquad ( 9 )$$

where λ represents the sum of four different terms over (±) signs

$$λ ≡ {\sum }_{\pm }^{4} \frac{sin [ \frac{π}{2} ( \frac{l Δ x}{a} \pm \frac{m Δ y}{b} \pm \frac{n Δ z}{h} ) ] cos [ π ( \frac{{lx}_{m}}{a} \pm \frac{{my}_{m}}{b} \pm \frac{{nz}_{m}}{h} ) ]}{( \frac{l Δ x}{a} \pm \frac{m Δ y}{b} \pm \frac{n Δ z}{h} )} , \qquad ( 10 )$$

with Δx=x₂−x₁; Δy=y₂−y; Δz=z₂−z₁; xₘ=(x₂+x₁)/2; yₘ=(y₂+y₁)/2; zₘ=(z₂+z₁)/2.
The exponential term in time induces rapid convergence of the triple series, except for very small time.

A similar development would follow for constant pressure external boundary formulations. Whereas a solution with a sealed boundary corresponds to a Neumann function, a constant pressure boundary yields a Green's function solution. The computation can be further generalized to represent a cell of spatially invariant properties within a larger heterogeneous reservoir system decomposed into intercommunicating blocks.

The more difficult term in Equation (8) to evaluate is the undamped term independent of time that contains spatial singularities. In dimensioned units, this is represented by

$$P ( x , y , z ; {x}_{1} , {y}_{1} , {z}_{1} ; α , β , γ ; L ) - \overline{P} = ( \frac{C}{L} ) {\int }_{0}^{L} [ ( {S}_{XYZ} + {S}_{YZ} ) + ( {S}_{XZ} + {S}_{Z} ) + ( {S}_{XY} + {S}_{Y} ) + {S}_{X} ] d s \qquad ( 11 )$$

where

$$C = ( \frac{4 π B μ q}{abh} ) .$$

Here, P̅ is the spatial average pressure, B is a volume correction factor for the fluid, since standard practice is to cite the production rate at surface conditions, μ is the fluid viscosity, q is the volumetric production rate, and a, b, and h are the box dimensions. If standard engineering units are used, i.e. viscosity in centipoises, production rate in barrels per day, permeability in millidarcies, pressure in psi, and lengths in feet, a conversion factor of

$$70.6 \frac{day \cdot {ft}^{3} \cdot md}{cp \cdot bbl}$$

is required to reconcile units. On the RHS of Equation (11), the point source solution consists of one triple infinite series (S_{XYZ}), three double infinite series, (S_{XY}, S_{XZ}, S_{YZ}), and three single infinite series (S_{X}, S_{Y}, S_{Z}). The triple infinite series, S_{XYZ}, is given as

$${S}_{XYZ} = ( \frac{8}{{π}^{2}} ) {\sum }_{l , m , n = 1}^{∞} \frac{\begin{matrix}cos ( \frac{π lx}{a} ) cos ( \frac{π my}{b} ) cos ( \frac{π nz}{h} ) \\ cos ( \frac{π {lx}_{o}}{a} ) cos ( \frac{π {my}_{o}}{b} ) cos ( \frac{π {nz}_{o}}{h} )\end{matrix}}{{{k}_{x} ( \frac{l}{a} )}^{2} + {{k}_{y} ( \frac{m}{b} )}^{2} + {{k}_{z} ( \frac{n}{h} )}^{2}} \qquad ( 12 )$$

The double infinite series, S_{YZ}, is given as

$${S}_{YZ} = ( \frac{4}{{π}^{2}} ) {\sum }_{m , n = 1}^{∞} \frac{cos ( \frac{π my}{b} ) cos ( \frac{π nz}{h} ) cos ( \frac{π {my}_{o}}{b} ) cos ( \frac{π {nz}_{o}}{h} )}{{{k}_{y} ( \frac{m}{b} )}^{2} + {{k}_{z} ( \frac{n}{h} )}^{2}} \qquad ( 13 )$$

Analogous series S_{XY} and S_{XZ} are obtained by change of variables. The single infinite series, S_{X}, is given as

$${S}_{X} = ( \frac{2}{{π}^{2}} ) {\sum }_{l = 1}^{∞} \frac{cos ( \frac{π lx}{a} ) cos ( \frac{π {lx}_{o}}{a} )}{{{k}_{x} ( \frac{l}{a} )}^{2}} \qquad ( 14 )$$

Analogous series S_{Y} and S_{Z} are obtained by change of variables.

The invention is not the delineation of Equation (8) but rather the reduction of these very slowly converging triple and double infinite series to readily computable parts for practical application on a computer. Any source term in Equation (11) without a dependency upon the integration parameter, s, is recognized as a trivial case, e.g. a well aligned with a principal axis, and is covered by developments in the public domain. The preferred embodiment of this invention would screen out the special cases where alternate computation schemes are advantageous, though these situations are tractable with the general formulas given, provided routine precautions are taken to avoid fatal computational errors, such as division by zero. For completeness, guidance regarding alternate schemes for these special cases is provided in a later section. The complementary solution with Dirichlet (constant pressure) boundary conditions is recovered by replacing all cosine terms with sine counterparts. Constant pressure conditions are especially relevant to cases of strong aquifer (large connected water reservoir) pressure support of hydrocarbon reservoirs. The Neumann case is further generalized herein to include material transport into or out of the cell through use of Green's Theorem and boundary integral equations. A comparable scheme can be generated starting with Equation (5).

### DETAILED DEVELOPMENT

For ease of notation, we divide the integral in Equation (11) into subintegrals. The insistence on direct integration using antiderivatives, also known to those skilled in the art as analytical integration, distinguishes the invention from prior art which approximates integration with numerical schemes. Analytical integration using antiderivatives successfully includes contributions from mathematical singularities without loss of accuracy, whereas strictly numerical approaches must evaluate integrands of spiked character, introducing unwarranted error and adding significantly to the computational burden.

P(x,y,Z;x₁,y₁,z₁;α,β,γ;L)− P̅=C[(I_{XYZ}+I_{YZ})+(I_{XZ}+I_{Z})+(I_{XY}+I_{Y})+I_{X}] (15)

The grouping of terms recognizes that certain expressions developed will contain lower dimensional series, eliminating the need for separate computations. The invention consists of a fast and accurate evaluation method for Equation (15) that avoids numerical quadrature schemes in favor of integration using antiderivatives with subsequent simplification using mathematical identities resulting in direct formulas and rapidly-convergent series and the successful implementation of such formulas and series summations on a computer for various industry needs requiring well productivity evaluation.

### Integrated Triple Infinite Series (I_{XYZ})

Beginning with the most complicated term of Equation (15), I_{XYZ}, we have

$${I}_{XYZ} ≡ \frac{1}{L} {\int }_{s = 0}^{L} {S}_{XYZ} d s = ( \frac{8}{{π}^{2} L} ) {\int }_{0}^{L} {\sum }_{l , m , n = 1}^{∞} \frac{\begin{matrix}cos ( \frac{π lx}{a} ) cos ( \frac{π my}{b} ) cos ( \frac{π nz}{h} ) \\ cos ( \frac{π {lx}_{o}}{a} ) cos ( \frac{π {my}_{o}}{b} ) cos ( \frac{π {nz}_{o}}{h} )\end{matrix}}{{{k}_{x} ( \frac{l}{a} )}^{2} + {{k}_{y} ( \frac{m}{b} )}^{2} + {{k}_{z} ( \frac{n}{h} )}^{2}} d s \qquad ( 16 )$$

Next we reduce the triple series to a double series and then integrate with respect to s. Rearranging and using the identity, 2 cos A cos B=cos(A+B)+cos(A−B),

$${I}_{XYZ} = ( \frac{4}{{π}^{2} L} ) {\int }_{0}^{L} {\sum }_{m , n = 1}^{∞} \{ \begin{matrix}\frac{cos ( \frac{π my}{b} ) cos ( \frac{π nz}{h} ) cos ( \frac{π {my}_{o}}{b} ) cos ( \frac{π {nz}_{o}}{h} )}{\frac{{k}_{x}}{{a}^{2}}} \cdot \\ {\sum }_{l = 1}^{∞} \frac{[ cos ( \frac{π l ( x + {x}_{o} )}{a} ) + cos ( \frac{π l ( x - {x}_{o} )}{a} ) ]}{{l}^{2} + {a}^{2} [ \frac{{k}_{y}}{{k}_{x}} {( \frac{m}{b} )}^{2} + \frac{{k}_{z}}{{k}_{x}} {( \frac{n}{h} )}^{2} ]}\end{matrix} \} d s \qquad ( 17 )$$

Applying the identity,

$${\sum }_{n = 1}^{∞} \frac{cos ( π nz ) }{{n}^{2} + {β}^{2}} = ( \frac{π}{2 β} ) \frac{cosh [ π β ( 1 - z ) ]}{sinh ( π β )} - \frac{1}{2 {β}^{2}} ,$$

0≦z≦2, from Gradshteyn and Rhyzik (2007, p. 47) and rewriting the hyperbolic functions in their exponential forms, we get

$${I}_{XYZ} = ( \frac{4}{{π}^{2} L} ) {\int }_{0}^{L} \{ \begin{matrix}( \frac{π a}{2 {k}_{x}} ) \cdot {\sum }_{m , n = 1}^{∞} \frac{\begin{matrix}cos ( \frac{π my}{b} ) cos ( \frac{π nz}{h} ) \\ cos ( \frac{π {my}_{o}}{b} ) cos ( \frac{π {nz}_{o}}{h} )\end{matrix}}{\begin{matrix}( 1 - {e}^{- 2 π a \sqrt{\frac{{k}_{y}}{{k}_{x}} \frac{{m}^{2}}{{b}^{2}} + \frac{{k}_{z}}{{k}_{x}} \frac{{n}^{2}}{{h}^{2}}} } ) \\ \sqrt{\frac{{k}_{y}}{{k}_{x}} \frac{{m}^{2}}{{b}^{2}} + \frac{{k}_{z}}{{k}_{x}} \frac{{n}^{2}}{{h}^{2}}}\end{matrix}} \\ ( \begin{matrix}{e}^{- π \sqrt{\frac{{k}_{y}}{{k}_{x}} \frac{{m}^{2}}{{b}^{2}} + \frac{{k}_{z}}{{k}_{x}} \frac{{n}^{2}}{{h}^{2}}} \vert x \pm {x}_{o} \vert} + \\ {e}^{- π \sqrt{\frac{{k}_{y}}{{k}_{x}} \frac{{m}^{2}}{{b}^{2}} + \frac{{k}_{z}}{{k}_{x}} \frac{{n}^{2}}{{h}^{2}}} ( 2 a - \vert x \pm {x}_{o} \vert )}\end{matrix} ) - \\ {\sum }_{m , n = 1}^{∞} \frac{\begin{matrix}cos ( \frac{π my}{b} ) cos ( \frac{π nz}{h} ) \\ cos ( \frac{π {my}_{o}}{b} ) cos ( \frac{π {nz}_{o}}{h} )\end{matrix}}{( {k}_{y} \frac{{m}^{2}}{{b}^{2}} + {k}_{z} \frac{{n}^{2}}{{h}^{2}} )}\end{matrix} \} d s \qquad ( 18 )$$

where the symbol “±” is used to denote the sum of two terms: one plus sign and the other with the minus sign. Here, the two “±” terms arise from the two cosine terms in the inner sum of Equation (17). We immediately identify the integral of second sum in Equation (18) as I_{YZ}, eliminating the need for a separate expression.

If we restrict our attention to geometries with orientations such that

$$( \frac{a}{\sqrt{{k}_{x}}} ) \geq max ( \frac{b}{\sqrt{{k}_{y}}} , \frac{h}{\sqrt{{k}_{z}}} ) ,$$

we note that, for m, n=1, 2, 3, . . .

$$max ( {e}^{- \frac{2 π am}{b} \sqrt{\frac{{k}_{y}}{{k}_{x}}}} , {e}^{- \frac{2 π an}{h} \frac{{k}_{z}}{{k}_{x}}} , {e}^{- 2 π a} \sqrt{\frac{{m}^{{2}_{{k}_{y}}}}{{b}^{{2}_{{k}_{x}}}} + \frac{{n}^{{2}_{{k}_{z}}}}{{h}^{{2}_{{k}_{x}}}}} ) < {e}^{- 2 π} < 0.00187 .$$

Thus, we can drop the exponential term in the denominator of Equation (18) with no practical loss of accuracy. This allows analytical reduction of the integral through identification of an appropriate antiderivative. We rewrite Equation (18) as

$$\begin{matrix}( {I}_{XYZ} + {I}_{YZ} ) \approx ( \frac{a}{{π}^{2} {Lk}_{x}} ) {\sum }_{m , n = 1}^{∞} cos ( \frac{π my}{b} ) cos ( \frac{π nz}{h} ) ( {I}_{1} + {I}_{2} + {I}_{3} + {I}_{4} ) \\ where & ( 19 ) \\ {I}_{j = 1 , 4} ≡ 2 π {\int }_{s = 0}^{s = L} {E}_{j} \cdot cos [ \frac{π m}{b} ( {y}_{1} + β s ) ] cos [ \frac{π n}{h} ( {z}_{1} + γ s ) ] d s \\ or & ( 20 ) \\ {I}_{j = 1 , 4} ≡ π {\int }_{s = 0}^{s = L} {E}_{j} \cdot cos π [ ( \frac{{m}_{{y}_{1}}}{b} \pm \frac{{n}_{{z}_{1}}}{h} ) + s ( \frac{m β}{b} \pm \frac{n γ}{h} ) ] d s & ( 21 )\end{matrix}$$

If we introduce the shorthand notation,

$${ξ}_{k} ≡ \sqrt{\frac{{k}_{y} {m}^{2}}{{k}_{x} {b}^{2}} + \frac{{k}_{z} {n}^{2}}{{k}_{x} {h}^{2}}} ,$$

$$\begin{matrix}{E}_{1} ≡ \frac{1}{{ξ}_{k}} {e}^{- π ( {x}_{1} + α s + x ) {ξ}_{k}} & ( 22 ) \\ {E}_{2} ≡ \frac{1}{{ξ}_{k}} {e}^{- π [ 2 a - ( {x}_{1} + α s + x ) ] {ξ}_{k}} & ( 23 ) \\ {E}_{3} ≡ \frac{1}{{ξ}_{k}} {e}^{- π \vert {x}_{1} + α s - x \vert {ξ}_{k}} and & ( 24 ) \\ {E}_{4} ≡ \frac{1}{{ξ}_{k}} {e}^{- π ( 2 a - \vert {x}_{1} + α s - x \vert ) {ξ}_{k}} & ( 25 )\end{matrix}$$

Using the identity

$$\int {e}^{at} \cdot cos ( bt ) d t ≡ \frac{{e}^{at} ( b sin ( bt ) + a cos ( bt ) )}{{a}^{2} + {b}^{2}} ,$$

we evaluate the integrals I₁, I_{,} I₃, and I₄. Integration of the first two terms, I₁ and I₂, is straightforward.

$$\begin{matrix}{I}_{1} ≡ \frac{1}{{( \frac{m β}{b} \pm \frac{n γ}{h} )}^{2} + {α}^{2} {ξ}_{k}^{2}} \{ \begin{matrix}{e}^{- π ( {x}_{2} + x ) {ξ}_{k}} [ \begin{matrix}\frac{1}{{ξ}_{k}} ( \frac{m β}{b} \pm \frac{n γ}{h} ) sin π ( \frac{{my}_{2}}{b} \pm \frac{{nz}_{2}}{h} ) - \\ α cos π ( \frac{{my}_{2}}{b} \pm \frac{{nz}_{2}}{h} )\end{matrix} ] - \\ {e}^{- π ( {x}_{1} + x ) {ξ}_{k}} [ \begin{matrix}\frac{1}{{ξ}_{k}} ( \frac{m β}{b} \pm \frac{n γ}{h} ) sin π ( \frac{{my}_{1}}{b} \pm \frac{{nz}_{1}}{h} ) - \\ α cos π ( \frac{{my}_{1}}{b} \pm \frac{{nz}_{1}}{h} )\end{matrix} ]\end{matrix} \} & ( 26 ) \\ {I}_{2} ≡ \frac{1}{{( \frac{m β}{b} \pm \frac{n γ}{h} )}^{2} + {α}^{2} {ξ}_{k}^{2}} \{ \begin{matrix}{e}^{- π [ 2 a - ( {x}_{2} + x ) ] {ξ}_{k}} [ \begin{matrix}\frac{1}{{ξ}_{k}} ( \frac{m β}{b} \pm \frac{n γ}{h} ) sin π ( \frac{{my}_{2}}{b} \pm \frac{{nz}_{2}}{h} ) + \\ α cos π ( \frac{{my}_{2}}{b} \pm \frac{{nz}_{2}}{h} )\end{matrix} ] - \\ {e}^{- π [ 2 a - ( {x}_{1} + x ) ] {ξ}_{k}} [ \begin{matrix}\frac{1}{{ξ}_{k}} ( \frac{m β}{b} \pm \frac{n γ}{h} ) sin π ( \frac{{my}_{1}}{b} \pm \frac{{nz}_{1}}{h} ) + \\ α cos π ( \frac{{my}_{1}}{b} \pm \frac{{nz}_{1}}{h} )\end{matrix} ]\end{matrix} \} & ( 27 )\end{matrix}$$

Integration of I₃ and I₄ is also straightforward if x<x₁ or x>x₂. However, within the well interval x₁≦x≦x₂, the integral is split to correctly represent absolute values.

$${I}_{3} ≡ \begin{matrix}( \frac{π}{{ξ}_{k}} ) \cdot {\int }_{s = 0}^{α s = x - {x}_{1}} {e}^{π ( {x}_{1} + α s - x ) {ξ}_{k}} \cdot cos π [ ( \frac{{my}_{1}}{b} \pm \frac{{nz}_{1}}{h} ) + s ( \frac{m β}{b} \pm \frac{n γ}{h} ) ] d s + \\ ( \frac{π}{{ξ}_{k}} ) \cdot {\int }_{α s = x - {x}_{1}}^{α s = {x}_{2} - {x}_{1}} {e}^{π ( x - {x}_{1} - α s ) {ξ}_{k}} \cdot cos π [ ( \frac{{my}_{1}}{b} \pm \frac{{nz}_{1}}{h} ) + s ( \frac{m β}{b} \pm \frac{n γ}{h} ) ] d s\end{matrix} \qquad ( 28 )$$

Integrating and simplifying, we obtain the general expression

$${I}_{3} ≡ \frac{1}{[ {( \frac{m β}{b} \pm \frac{n γ}{h} )}^{2} + {α}^{2} {ξ}_{k}^{2} ]} \cdot ( \begin{matrix}H ( x - {x}_{1} ) \cdot H ( {x}_{2} - x ) \cdot 2 α cos π ( \begin{matrix}\frac{m}{b} [ {y}_{1} + \frac{β}{α} ( x - {x}_{1} ) ] \pm \\ \frac{n}{h} [ {z}_{1} + \frac{γ}{α} ( x - {x}_{1} ) ]\end{matrix} ) + \\ {e}^{- π \vert x - {x}_{2} \vert {ξ}_{k}} [ \begin{matrix}\frac{1}{{ξ}_{k}} ( \frac{m β}{b} \pm \frac{n γ}{h} ) sin π ( \frac{m}{b} {y}_{2} \pm \frac{n}{h} {z}_{2} ) + \\ α \cdot sign ( x - {x}_{2} ) cos π ( \frac{m}{b} {y}_{2} \pm \frac{n}{h} {z}_{2} )\end{matrix} ] - \\ {e}^{- π \vert x - {x}_{1} \vert {ξ}_{k}} [ \begin{matrix}\frac{1}{{ξ}_{k}} ( \frac{m β}{b} \pm \frac{n γ}{h} ) sin π ( \frac{m}{b} {y}_{1} \pm \frac{n}{h} {z}_{1} ) + \\ α \cdot sign ( x - {x}_{1} ) cos π ( \frac{m}{b} {y}_{1} \pm \frac{n}{h} {z}_{1} )\end{matrix} ]\end{matrix} \} \qquad ( 29 )$$

where the Heavyside function, H(x−x₁), was introduced to capture the first term only when x is within the interval, [x₁, x₂]. Following a similar approach and dropping the exponential term,

$$\frac{\begin{matrix}H ( x - {x}_{1} ) \cdot H ( {x}_{2} - x ) \cdot 2 α \cdot {e}^{- 2 π a {ξ}_{k}} \cdot \\ cos π ( \frac{m}{b} [ {y}_{1} + \frac{β}{α} ( x - {x}_{1} ) ] \pm \frac{n}{h} [ {z}_{1} + \frac{γ}{α} ( x - {x}_{1} ) ] )\end{matrix}}{[ {( \frac{m β}{b} \pm \frac{n γ}{h} )}^{2} + {α}^{2} {ξ}_{k}^{2} ]} ,$$

### we get I₄.

$${I}_{4} ≡ \frac{1}{[ {( \frac{m β}{b} \pm \frac{n γ}{h} )}^{2} + {α}^{2} {ξ}_{k}^{2} ]} \cdot \{ \begin{matrix}{e}^{- π ( 2 a - \vert x - {x}_{2} \vert {ξ}_{k}} [ \begin{matrix}\frac{1}{{ξ}_{k}} ( \frac{m β}{b} \pm \frac{n γ}{h} ) sin π ( \frac{m}{b} {y}_{2} \pm \frac{n}{h} {z}_{2} ) + \\ α \cdot sign ( {x}_{2} - x ) cos π ( \frac{m}{b} {y}_{2} \pm \frac{n}{h} {z}_{2} )\end{matrix} ] - \\ {e}^{- π ( 2 a - \vert x - {x}_{1} \vert {ξ}_{k}} [ \begin{matrix}\frac{1}{{ξ}_{k}} ( \frac{m β}{b} \pm \frac{n γ}{h} ) sin π ( \frac{m}{b} {y}_{1} \pm \frac{n}{h} {z}_{1} ) + \\ α \cdot sign ( {x}_{1} - x ) cos π ( \frac{m}{b} {y}_{1} \pm \frac{n}{h} {z}_{1} )\end{matrix} ]\end{matrix} \} \qquad ( 30 )$$

We have thus derived fast-computing formulas for the integrals, (I_{XYZ}+I_{YZ}), involving the triple infinite series (S_{XYZ}+S_{YZ}) of Equations (11) and (15), using Equations (26), (27), (29), and (30).

In order to further distance the described invention from prior art using numerical methods, we note that once recast in the form of Eq (29), it should be obvious to one skilled in the art that the leading term in the I₃ component contains no exponential damping to expedite convergence, but rather it can be expressed by direct analytical formulas containing logarithmic terms upon application of the standard reduction formula given after Eq (17) and subsequent use of generalized analytical reduction procedures as demonstrated in prior art application for wells of restricted orientation and lower dimensionality (McCann et al., 2001). Proper and expedient evaluation of the term containing I₃ is necessary, as this terms typically contributes significantly in the vicinity of the wellbore.

### Integrated Double Infinite Series (I_{XY} and I_{XZ})

Recalling I_{YZ} is exactly cancelled by a term in I_{XYZ}, we focus on the terms (I_{XY}+I_{Y}) and (I_{XZ}+I_{Z}). Fast-computing terms for the double infinite series could be accomplished by following a similar procedure; however, they can more easily be obtained as special cases of the prior development. For example, taking n=0, eliminates the series in z. We note that the coefficient automatically takes on ½ values by omitting the repetition of “±” when n=0. Thus, with n=0 (and z absent) in Equation (19), we get

$$( {I}_{XY} + {I}_{Y} ) \approx ( \frac{a}{{π}^{2} {Lk}_{x}} ) {\sum }_{m = 1}^{∞} cos ( \frac{π my}{b} ) ( {I}_{1} + {I}_{2} + {I}_{3} + {I}_{4} ) \qquad ( 31 )$$

or, in terms of the exponential functions used in Equations (26-30), with

$${F}_{1} ( x , {x}_{i} ; m , n ) ≡ \frac{{e}^{- π ( {x}_{i} + x )} \sqrt{\frac{{k}_{y} {m}^{2}}{{k}_{x} {b}^{2}} + \frac{{k}_{z} {n}^{2}}{{k}_{x} {h}^{2}}}}{\sqrt{\frac{{k}_{y} {m}^{2}}{{k}_{x} {b}^{2}} + \frac{{k}_{z} {n}^{2}}{{k}_{x} {h}^{2}}}} , \\ {F}_{2} ( x , {x}_{i} ; m , n ) ≡ \frac{{e}^{- π [ 2 a - ( {x}_{i} + x ) ]} \sqrt{\frac{{k}_{y} {m}^{2}}{{k}_{x} {b}^{2}} + \frac{{k}_{z} {n}^{2}}{{k}_{x} {h}^{2}}}}{\sqrt{\frac{{k}_{y} {m}^{2}}{{k}_{x} {b}^{2}} + \frac{{k}_{z} {n}^{2}}{{k}_{x} {h}^{2}}}} , \\ {F}_{3} ( x , {x}_{i} ; m , n ) ≡ \frac{{e}^{- π \vert {x}_{i} + x \vert} \sqrt{\frac{{k}_{y} {m}^{2}}{{k}_{x} {b}^{2}} + \frac{{k}_{z} {n}^{2}}{{k}_{x} {h}^{2}}}}{\sqrt{\frac{{k}_{y} {m}^{2}}{{k}_{x} {b}^{2}} + \frac{{k}_{z} {n}^{2}}{{k}_{x} {h}^{2}}}} , and \\ \\ {F}_{4} ( x , {x}_{i} ; m , n ) ≡ \frac{{e}^{- π ( 2 a - \vert {x}_{i} - x \vert )} \sqrt{\frac{{k}_{y} {m}^{2}}{{k}_{x} {b}^{2}} + \frac{{k}_{z} {n}^{2}}{{k}_{x} {h}^{2}}}}{\sqrt{\frac{{k}_{y} {m}^{2}}{{k}_{x} {b}^{2}} + \frac{{k}_{z} {n}^{2}}{{k}_{x} {h}^{2}}}} , for i = 1 , 2 , \\ ( {I}_{XY} + {I}_{Y} ) \approx \frac{{ab}^{2}}{{π}^{2} L ( {α}^{2} {k}_{y} + {β}^{2} {k}_{x} )} \{ \begin{matrix}2 α \cdot H ( x - {x}_{1} ) \cdot H ( {x}_{2} - x ) \cdot \\ {\sum }_{m = 1}^{∞} \frac{1}{{m}^{2}} cos ( \frac{π my}{b} ) cos π ( \frac{m}{b} [ \begin{matrix}{y}_{1} + \\ \frac{β}{α} ( x - {x}_{1} )\end{matrix} ] ) + \\ {\sum }_{j = 1}^{4} {\sum }_{m = 1}^{∞} ( \frac{1}{{m}^{2}} ) {F}_{j} ( x , {x}_{2} ; m , 0 ) cos ( \frac{π my}{b} ) \\ [ \begin{matrix}β \sqrt{\frac{{k}_{x}}{{k}_{y}}} \cdot sin π ( \frac{{my}_{2}}{b} ) + \\ α \cdot {λ}_{j} ( x , {x}_{2} ) \cdot cos π ( \frac{{my}_{2}}{b} )\end{matrix} ] - \\ {\sum }_{j = 1}^{4} {\sum }_{m = 1}^{∞} ( \frac{1}{{m}^{2}} ) {F}_{j} ( x , {x}_{1} ; m , 0 ) cos ( \frac{π my}{b} ) \\ [ \begin{matrix}β \sqrt{\frac{{k}_{x}}{{k}_{y}}} \cdot sin π ( \frac{{my}_{1}}{b} ) + \\ α \cdot {λ}_{j} ( x , {x}_{1} ) \cdot cos π ( \frac{{my}_{1}}{b} )\end{matrix} ]\end{matrix} \} \qquad ( 32 )$$

where ξₖ was simplified by setting n=0, and

$$\begin{matrix}{λ}_{1} ( x , {x}_{i} ) = - 1 \\ {λ}_{2} ( x , {x}_{i} ) = 1 \\ {λ}_{3} ( x , {x}_{i} ) = sign ( x - {x}_{i} ) \\ {λ}_{4} ( x , {x}_{i} ) = sign ( {x}_{i} - x )\end{matrix} \} , i = 1 , 2 \qquad ( 33 )$$

We get an analogous expression for (I_{XZ}+I_{Z}). Thus, with m=0 (and y absent), in Equation (19)

$$( {I}_{XZ} + {I}_{Z} ) \approx \frac{{ah}^{2}}{{π}^{2} L ( {α}^{2} {k}_{z} + {γ}^{2} {k}_{x} )} \{ \begin{matrix}2 α \cdot H ( x - {x}_{1} ) \cdot H ( {x}_{2} - x ) \cdot \\ {\sum }_{n = 1}^{∞} \frac{1}{{n}^{2}} cos ( \frac{π nz}{h} ) cos π ( \frac{n}{h} [ {z}_{1} + \frac{γ}{α} ( x - {x}_{1} ) ] ) + \\ {\sum }_{j = 1}^{4} {\sum }_{n = 1}^{∞} ( \frac{1}{{n}^{2}} ) {F}_{j} ( x , {x}_{2} ; 0 , n ) cos ( \frac{π nz}{h} ) \\ [ \begin{matrix}γ \sqrt{\frac{{k}_{x}}{{k}_{z}}} \cdot sin π ( \frac{{nz}_{2}}{h} ) + \\ α \cdot {λ}_{j} ( x , {x}_{2} ) \cdot cos π ( \frac{{nz}_{2}}{h} )\end{matrix} ] - \\ {\sum }_{j = 1}^{4} {\sum }_{n = 1}^{∞} ( \frac{1}{{n}^{2}} ) {F}_{j} ( x , {x}_{1} ; 0 , n ) cos ( \frac{π nz}{h} ) \\ [ \begin{matrix}γ \sqrt{\frac{{k}_{x}}{{k}_{z}}} \cdot sin π ( \frac{{nz}_{1}}{h} ) + \\ α \cdot {λ}_{j} ( x , {x}_{1} ) \cdot cos π ( \frac{{nz}_{1}}{h} )\end{matrix} ]\end{matrix} \} \qquad ( 34 )$$

where Fⱼs are as previously defined with m=0.
Note that the first sums of the RHS of Equations (32) and (34) admit polynomial formulas, recognizing

$$2 \cdot {\sum }_{n = 1}^{∞} \frac{cos ( π {n}_{{x}_{1}} ) cos ( π {n}_{{x}_{2}} )}{{n}^{2}} ≡ {π}^{2} [ \frac{1}{3} - max ( {x}_{1} , {x}_{2} ) + \frac{{x}_{1}^{2} + {x}_{2}^{2}}{2} ] . \qquad ( 35 )$$

### Integrated Single Infinite Series (I_{X})

The integration of single series solution, S_{X}, is straightforward.

$$\begin{matrix}{I}_{X} ≡ ( \frac{{2}_{a}^{2}}{{π}^{2} {L}_{{k}_{x}}} ) {\int }_{0}^{L} {\sum }_{l = 1}^{∞} \frac{cos ( \frac{π lx}{a} ) cos ( \frac{π l ( {x}_{1} + α s )}{a} )}{{l}^{2}} d s & ( 36 ) \\ {I}_{X} ≡ ( \frac{{2}_{a}^{2}}{{π}^{2} {L}_{{k}_{x}}} ) {\sum }_{l = 1}^{∞} \frac{cos ( \frac{π lx}{a} ) [ sin ( \frac{π {l}_{{x}_{2}}}{a} ) - sin ( \frac{π {l}_{{x}_{1}}}{a} ) ]}{\frac{π α {l}^{3}}{a}} & ( 37 ) \\ {I}_{X} ≡ ( \frac{{a}^{3}}{{π}^{3} α {L}_{{k}_{x}}} ) {\sum }_{l = 1}^{∞} \frac{sin [ \frac{π l}{a} ( {x}_{2} \pm x ) ] - sin [ \frac{π l}{a} ( {x}_{1} \pm x ) ]}{ {l}^{3}} \\ Thus , & ( 38 ) \\ {I}_{X} ≡ ( \frac{{a}^{3}}{{π}^{3} α {L}_{{k}_{x}}} ) [ \begin{matrix}{F}_{3} ( \frac{{x}_{2} + x}{a} ) + {F}_{3} ( \frac{{x}_{2} - x}{a} ) - \\ {F}_{3} ( \frac{{x}_{1} + x}{a} ) - {F}_{3} ( \frac{{x}_{1} - x}{a} )\end{matrix} ] \\ where & ( 39 ) \\ {F}_{3} ( z ) ≡ {\sum }_{n = 1}^{∞} \frac{sin ( π nz )}{{n}^{3}} = {π}^{3} \cdot z \cdot [ \frac{1}{6} - \frac{\vert z \vert}{4} ( 1 - \frac{\vert z \vert}{3} ) ] , 0 \leq \vert z \vert \leq 2 & ( 40 )\end{matrix}$$

according to Gradshteyn and Rhyzik (2007, p. 47). In summary, the pressure at an arbitrary observation point (x, y, z) in a sealed 3-D box with spatially invariant, but possibly anisotropic, permeability (kₓ, k_{y}, k_{z}) due to a line source segment of unit strength from (x₁, y₁, z₁) to (x₂, y₂, z₂) is given by Equation (8) and the combination of elements reduced to easily computable expressions represented by Equations (9, 15, 26, 27, 29, 30, 32, 34, and 39) for evaluation by a computer. To illustrate, the dimensionless pressure distribution,

$$\tilde{P} ( x , y , z ) ≡ \frac{( P ( x , y , z ) - \overline{P} ) abh}{4 π B μ q} ,$$

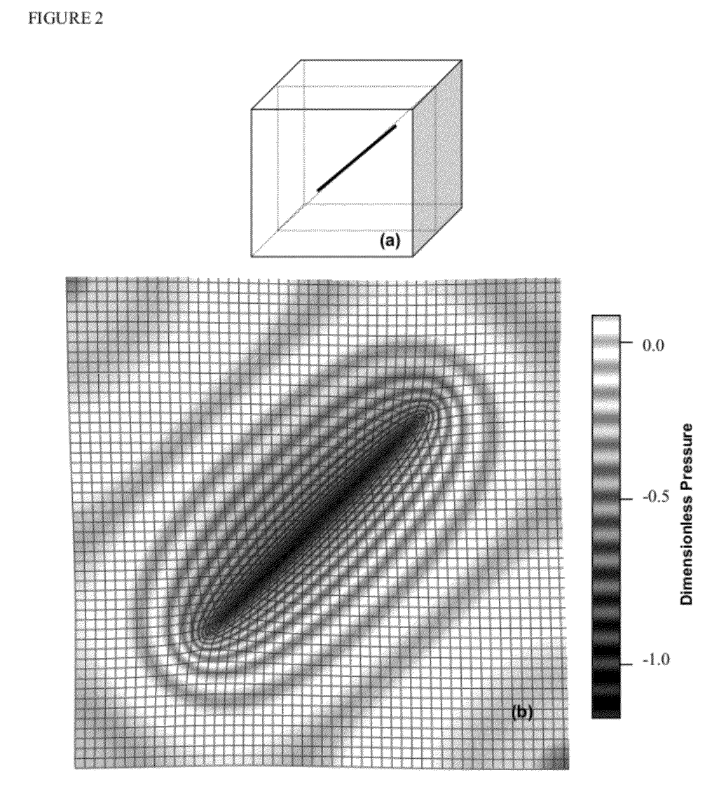

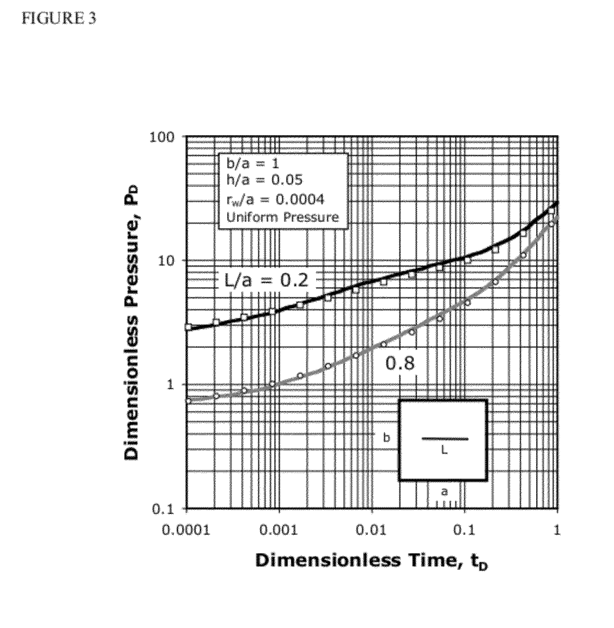

for the central XZ slice in the plane containing a well with endpoints (x₁, y₁, z₁)=(0.25, 0.5, 0.25) and (x₂, y₂, z₂)=(0.75, 0.5, 0.75) in a cube with isotropic permeability is shown in FIG. 2.

### Validation

We validate the computation scheme against literature solutions for degenerate cases, i.e. simpler special cases of the new invention not utilizing its generality. In particular, we compare the invention with the three-dimensional solution given by Economides et al. (1996) for the transient behavior of centralized partially-penetrating horizontal wells. FIG. 3 shows the dimensionless well pressure versus time, as defined by these authors, for the case of uniform wellbore pressure, for wells of length L/a=0.2 and 0.8, centered in a square drainage area of thickness h/a=0.05, with isotropic permeability and well radius r_{w}/a=0.0004. The solid lines represent the digitized data of Economides et al. (1996), while the data points represent computations from the described invention. Of particular note is the generation of this data in under 0.25 seconds on a 2 GHz PC.

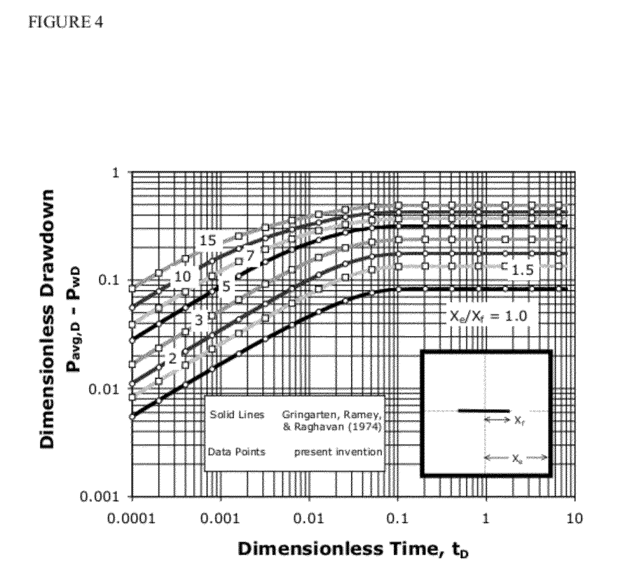

We further validate the invention through comparison with the two-dimensional solution for transient behavior of centralized, partially-penetrating fractures given by Gringarten et al. (1974). FIG. 4 gives the results of Gringarten et al. recast as the dimensionless pressure difference between the system average pressure and the pressure observed at the midpoint versus dimensionless time for uniform flux fractures of varying length. The solid lines represent the tabular data of Gringarten et al. (1974), while the data points indicate computations from a two-dimensional subset of the described invention.

### Two Dimensional Application

The two-dimensional case is also of practical interest and is recognized as a contained embodiment of the above development. When the Neumann function for a point source is integrated along a linear segment in the XY plane (which constitutes a planar source in 3-D), we merely pick up a subset of the developed terms for three dimensions.

P(x,y;x₁,y₁,α,β,L)− P̅=C·[(I_{XY}+I_{Y})+I_{X}] (41)

The 2-D result is particularly useful in modeling of fractured wells or inclined wells in thin reservoirs for dimensionless values of the ratio

$$( \frac{a}{h} \sqrt{\frac{{k}_{z}}{{k}_{x}}} )$$

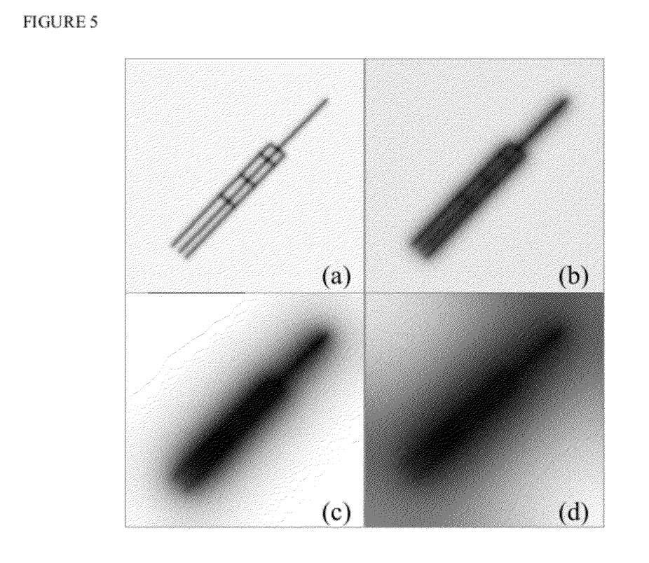

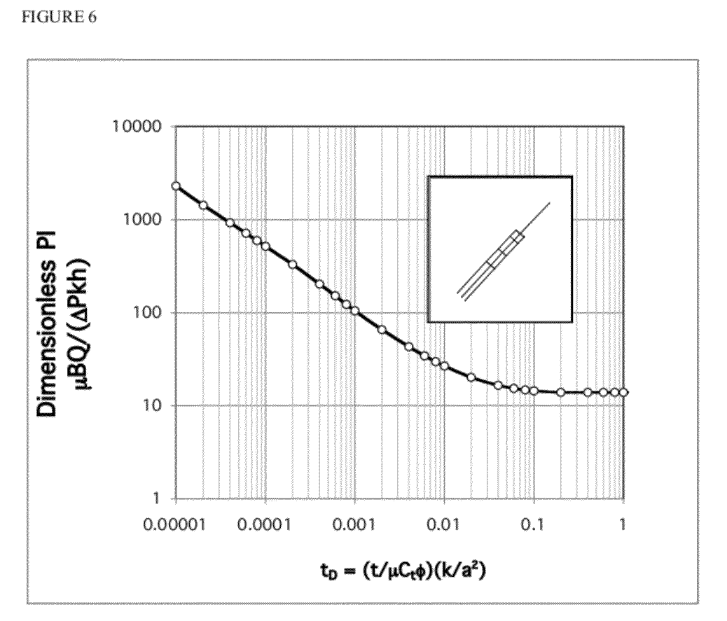

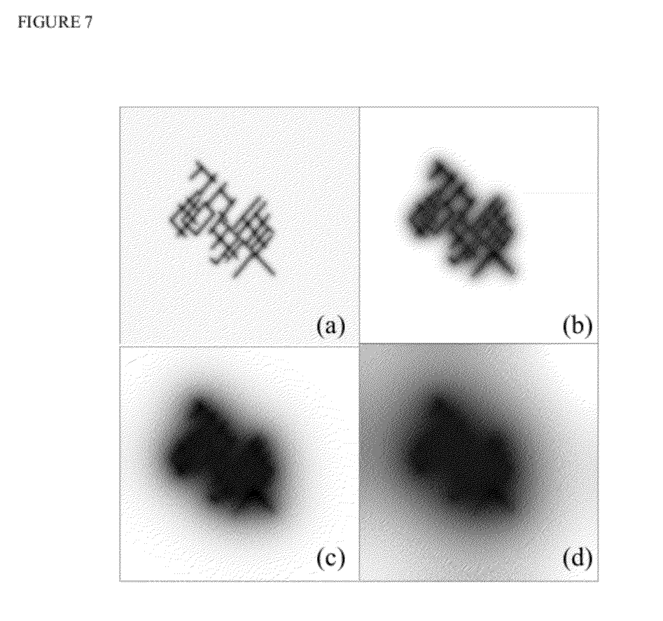

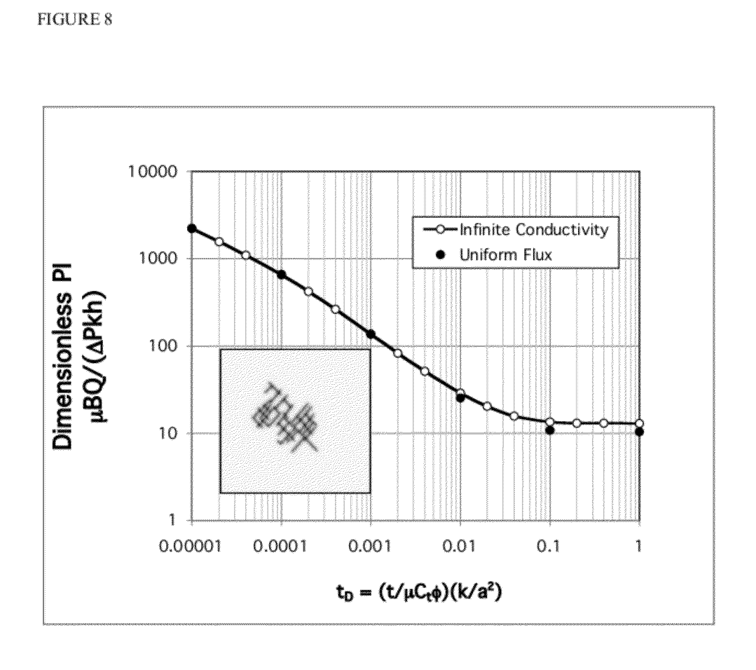

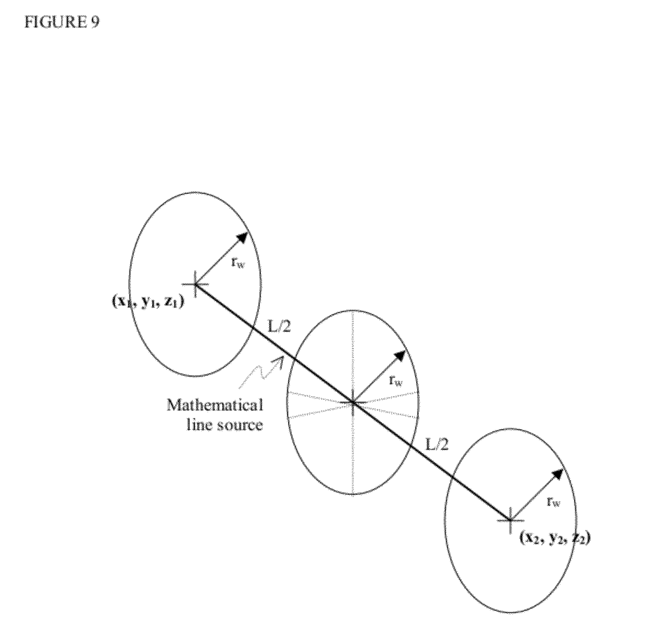

exceeding 5. FIGS. 5-8 show application to two-dimensional modeling the dimensionless pressure with respect to the average pressure in complex fracture networks using literature interpretations of fracture patterns in Barnett shale. FIGS. 5 and 6 pertain to a stimulated vertical Barnett well (Mayerhofer et al., 2006), while FIGS. 7 and 8 are for a fractured horizontal well in the Barnett shale (Fisher et al., 2004). In unconventional resources, the reservoir permeability is low such that the practical lifetime of well operation is captured in the early transients. These results are a demonstration of a reduction to practice of the described invention. While the obtained dimensionless well productivity indices were obtained on the basis a unit volume of fluid withdrawal per unit time, they may be converted for variable rate interpretation using standard convolution methods to capture the high initial production rate (IPR) and rapid decline common in such unconventional reservoirs.

### Well Pressure and Well Productivity

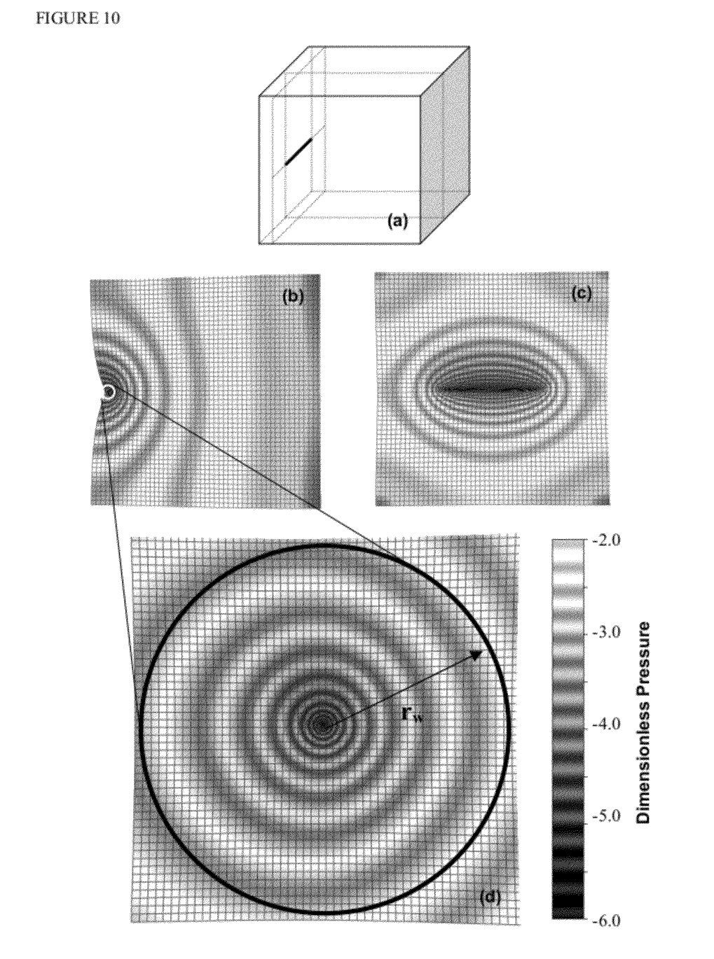

Of particular interest is the observation point a distance r_{w}, the well radius, from the mathematical line sink. Of historical interest has been the value at the midpoint of the well (see FIG. 9) and another at roughly 70% of the distance from the midpoint to the well tip, where the uniform flux well boundary condition yields approximately the same characteristic value for pressure as does a uniform pressure boundary condition for symmetrically-placed wells with respect to cell boundaries, though the method allows for pressure determination at any specified point or sets of points. The determination of the pressure observable at a well location in this manner has been reduced to practice. In FIG. 10, we see the pressure distribution for a partially penetrating horizontal well near one of the boundaries and an exploded view of the pressure distribution in the area immediately surrounding the mathematical line source for the plane normal to the well passing through the well midpoint. For the line source with endpoints (x₁, y₁, z₁) and (x₂, y₂, z₂) and direction cosines (α, β, γ), the plane normal to the line passing through the midpoints,

$$( {x}_{m} , {y}_{m} , {z}_{m} ) ≡ ( \frac{{x}_{1} + {x}_{2}}{2} , \frac{{y}_{1} + {y}_{2}}{2} , \frac{{z}_{1} + {z}_{2}}{2} ) ,$$

is represented by the equation

α(x−xₘ)+β(y−yₘ)+γ(z−zₘ)=0 (42)

Points on this plane a radial distance equal to the well radius, r_{w}, from the midpoint are given by

(x−xₘ)²+(y−yₘ)²+(z−zₘ)²=r²_{w} (43)

In one embodiment of this invention, we take a limited number of such points, setting successively x=xₘ, y=yₘ, and z=zₘ, yielding the observation points

$$( {x}_{m} , {y}_{m} ∓ \frac{{γ}_{{r}_{w}}}{\sqrt{{β}^{2} + {γ}^{2}}} , {z}_{m} \pm \frac{{β}_{{r}_{w}} }{\sqrt{{β}^{2} + {γ}^{2}}} ) \\ ( {x}_{m} ∓ \frac{{γ}_{{r}_{w}}}{\sqrt{{α}^{2} + {γ}^{2}}} , {y}_{m} , {z}_{m} \pm \frac{{α}_{{r}_{w}}}{\sqrt{{α}^{2} + {γ}^{2}}} ) \\ ( {x}_{m} ∓ \frac{{β}_{{r}_{w}}}{\sqrt{{α}^{2} + {β}^{2}}} , {y}_{m} \pm \frac{{α}_{{r}_{w}}}{\sqrt{{α}^{2} + {β}^{2}}} , {z}_{m} ) \qquad ( 44 )$$

We recommend taking an average of unique observation points along the wellpath and averaging those, if desired, to get an overall representative average for a well composed of multiple segments.

### Advanced Well Designs

A well trajectory can be approximated by any number of linear segments. By the superposition principle, the effects of all such line source segments on the pressure at an observation point (x, y, z) are additive. Thus, for any number of line source segments, N_{seg}, within the box, we can write the expression for pressure as

$$P ( x , y , z ; {x}_{1 i} , {y}_{1 i} , {z}_{1 i} ; {α}_{i} , {β}_{i} , {γ}_{i} ; {L}_{i} , i = 1 , {N}_{seg} ) - \overline{P} = {\sum }_{i = 1}^{Nseg} {C}_{i} [ \begin{matrix}( {I}_{{XYZ}_{i}} + {I}_{{YZ}_{i}} ) + \\ ( {I}_{{XZ}_{i}} + {I}_{{Z}_{i}} ) + ( {I}_{{XY}_{i}} + {I}_{{Y}_{i}} ) + {I}_{{X}_{i}}\end{matrix} ] \qquad ( 45 )$$

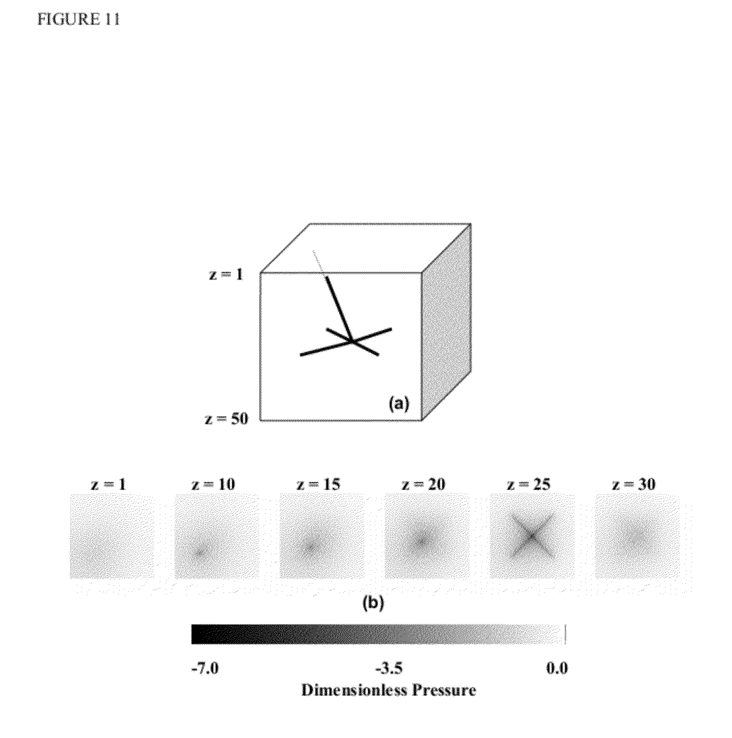

The method where multiple line segments approximate an arbitrary wellbore trajectory and act in unison to determine the pressure distribution has been reduced to practice. In FIG. 11, we see the dimensionless pressure for different XY slices through a three-dimensional cube of isotropic permeability with a partially penetrating motherbore and four lateral wellbores as illustrated. The fractional length of the line segment in comparison with the total well length is an appropriate weighting factor for this uniform flux approach.

### Infinite and Finite Conductivity Wells

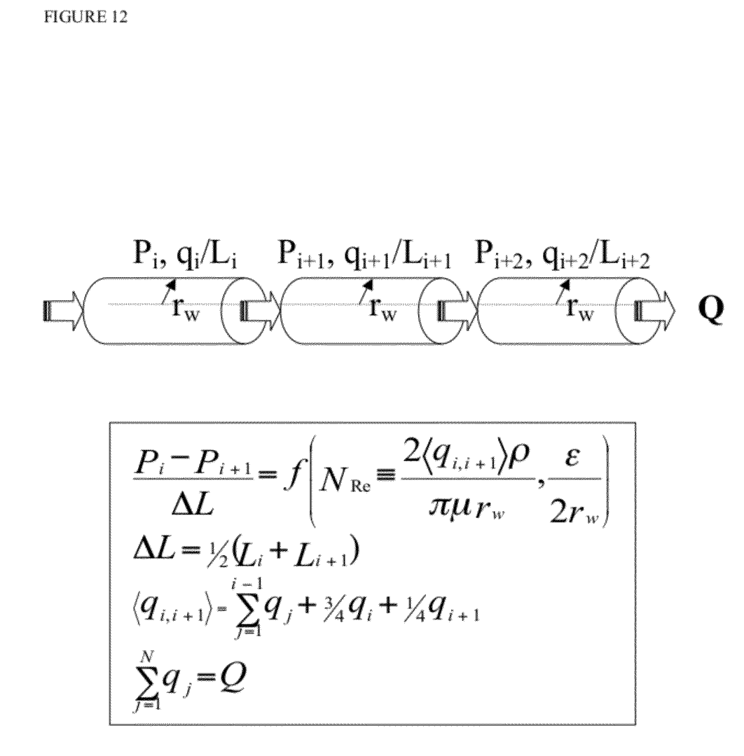

The segmented well can be further modified to describe the case where pressure rather than flux is specified. Using a constitutive relationship between pressure drop and flow rate within a well, one can pose and solve a set of equations to describe the pressure distribution along a well with unknown segment flux but known overall production rate, as illustrated in FIG. 12. The problem could likewise be posed with a pressure constraint, such as a pump mechanical limit, and unknown overall flux. The so-called infinite conductivity well (uniform pressure) is a special case of this algorithm where pressure is unknown but uniform along the well. An expression for pressure difference between adjacent segments, along with the overall material balance for the well, closes the system of equations. This has been demonstrated in prior art (Ouyang & Aziz, 2001) using less accurate, strictly numerically integrated point source formulas to compute inflow for nonconventional wells.

For a uniform pressure well boundary condition, a set of pressure matching expressions using the described invention could be solved directly by any number of standard linear matrix solvers. Alternatively, uniform pressure cases can be readily evaluated within the context of the present invention using an iterative procedure. A uniform flux initial guess returns the productivity index for each segment. The reciprocal of the computed productivity index is normalized and used as the updated flux. The process is repeated until convergence. Multiple passes are required only to account for well interference effects. The described iterative procedure has been reduced to practice in software to give the flux in each well segment.

Realistic pressure drop within wellbores can be computed directly by passing a set of pressure and flux matching expressions along with a material balance and constitutive relationship between pressure gradient and flow rate to any number of standard linear matrix solvers. The solver can likewise be bypassed in finite conductivity well cases by computing a productivity index for each segment with a uniform flux initial guess, computing the flux required to give the specified pressure drop along the well segment using a constitutive equation, such as that for pipe flow using friction factor concepts, and repeating the process until convergence.

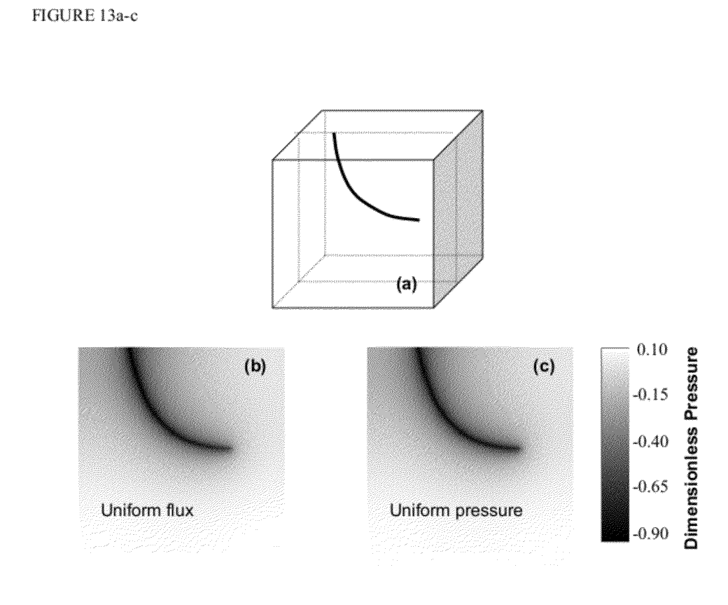

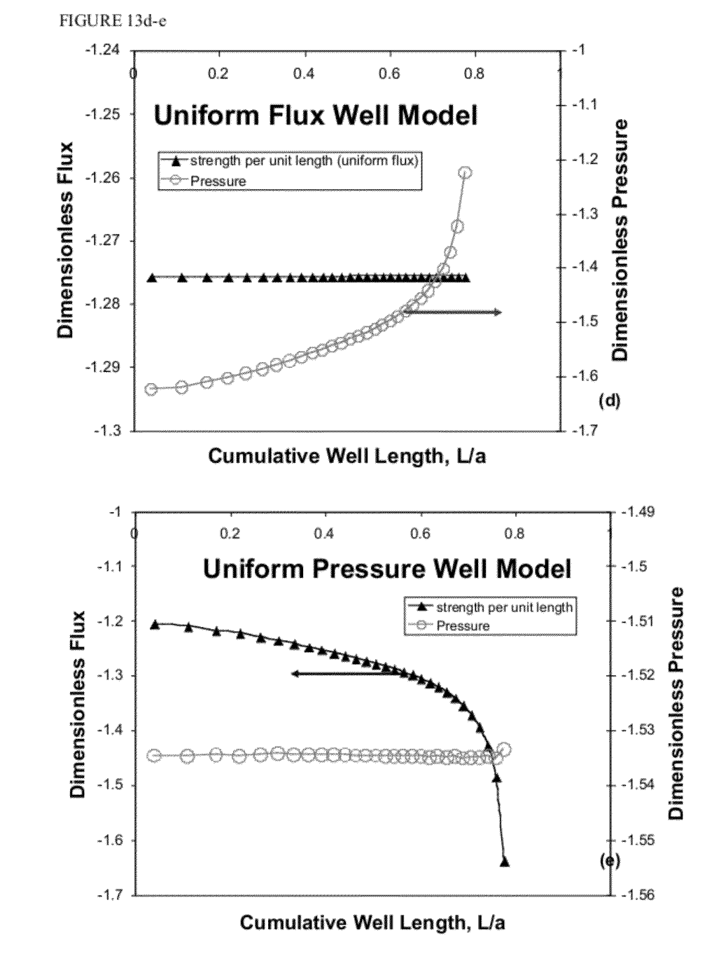

FIG. 13 illustrates the difference between uniform flux and uniform pressure cases with the same curvilinear well trajectory decomposed into 29 piecewise linear segments. FIG. 13a shows the dimensionless pressure distribution for the central plane containing the well with identical flux per unit length. FIG. 13b shows the dimensionless pressure for the same slice and same well trajectory after the iterative procedure to yield equal pressure at each segment midpoint with adjustment of flux. The pressure and flux distributions for these two cases are presented in FIGS. 13c & 13d.

### Generalization to Open Systems

The Neumann function solution can be further generalized to include material transport at the faces of the rectangular cell using Green's Theorem. In this method, the equation becomes

$$P ( \overline{x} ) = \overline{P} - ( \frac{1}{{q}_{o}} ) \cdot {\sum }_{i} {q}_{wi} \cdot {N}_{L} ( \overline{x} , {\overline{x}}_{1 i} , {\overline{x}}_{2 i} ) - ( \frac{1}{{q}_{o}} ) {\int }_{S}^{ } {N}_{o} ( \overline{x} , σ ) g ( σ ) d σ \qquad ( 46 )$$

where x̅ is the observation point location, qₒ is a reference production rate, q_{wi} is the production rate for segment i, N_{L} are the Neumann functions for the linear segments ( x̅₁ᵢ, x̅₂ᵢ), and the product of the normal flux, g(σ), and point source Neumann function, Nₒ, is integrated over open boundary surfaces, S. Equation (46) is especially relevant for the choice of observation point for well pressure characterization, r̅_{w}. If all six faces were open for material transport, the integration would be broken into six separate integrations, one for each face. Partial integrations are allowed with the flux defined to be zero (and hence noncontributing) on closed portions of the boundary. The integrations in Equation (46) can be estimated numerically by any one of a variety of standard techniques, such as Gaussian quadrature or the trapezoidal rule. In this fashion, pressure support to the cell by water influx is accommodated. Flux can be easily included from any of the faces to model physical cases. In this invention, the fast computing Equation (8) is used for N_{L}.

In the limit of strong aquifer support, the pressure at the boundary remains constant, as water is supplied to fully account for fluid withdrawn from the cell via the well. In the strong aquifer limit, the Green's function is recommended over the Neumann function. The derivation is repeated for the analogous case with Sine functions in place of Cosines in Equations (12), (13), and (14).

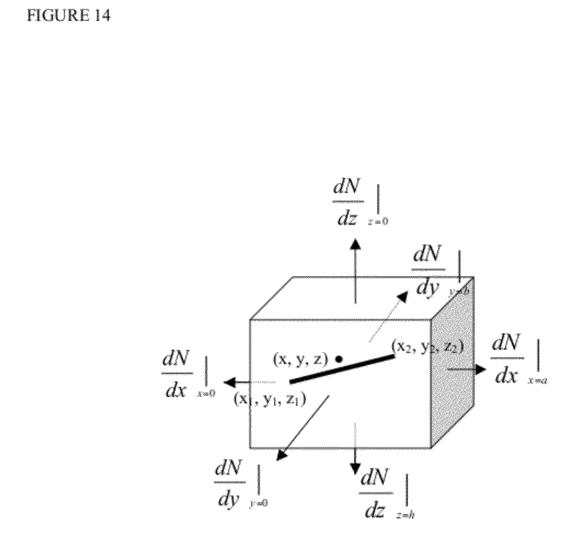

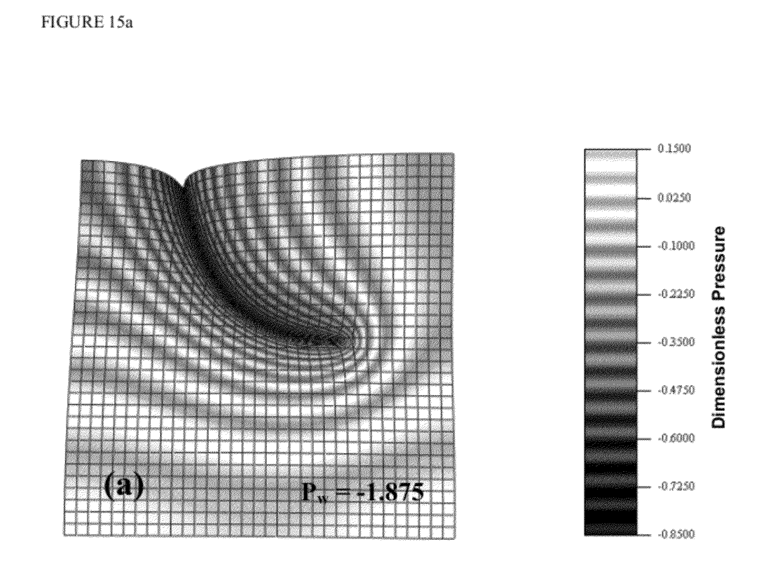

An important special case using Equation (46) for open systems is when the flux is presumed to be uniformly distributed across a fully open face. In traditional numerical reservoir simulators, only a single value of flux is associated with each planar interface of adjoining cells, as illustrated in FIG. 14. In the absence of a detailed flux distribution pattern, a uniform flux distribution allows analytic reduction of the integral in Equation (46). For example, replacing the normal flux with a representative average value, [symbol] g [symbol] ,

$$〈 g 〉 {\int }_{0}^{b} {\int }_{0}^{h} {N}_{o} ( x , y , z ; {x}_{o} = 0 , {y}_{o} , {z}_{o} ) d {y}_{o} d {z}_{o} \frac{〈 g 〉}{bh} ( \frac{2 {a}^{2}}{{π}^{2} {k}_{x}} ) {\int }_{0}^{b} {\int }_{0}^{h} {\sum }_{l = 1}^{∞} \frac{cos ( \frac{π lx}{a} )}{{l}^{2}} d {y}_{o} d {z}_{o} = 〈 g 〉 ( \frac{2 {a}^{2}}{{k}_{x}} ) [ \frac{1}{6} - \frac{x}{2 a} + {( \frac{x}{2 a} )}^{2} ] \qquad ( 47 )$$

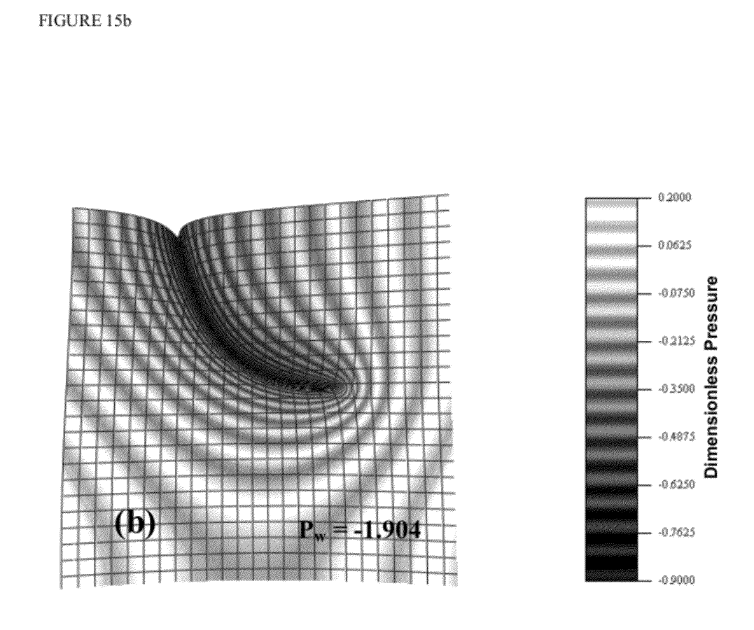

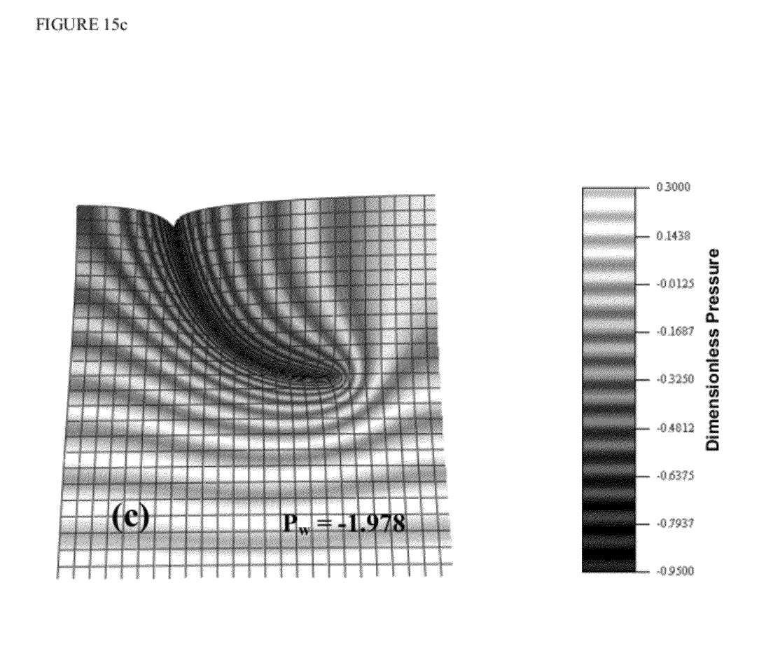

Similar expressions apply for the other five faces with switch of variables and the dummy variable, x, representing the normal distance to the face over which the Neumann function is integrated. FIG. 15 shows the pressure distribution across the central slice containing the well for the uniform pressure case developed in FIG. 13 for three external boundary situations: (a) sealed boundaries, (b) open lateral boundaries, and (c) influx from the bottom face. The well pressure, which is actually the driving force for production since we have used a degree of freedom to set the average reservoir pressure to zero in these calculations, is sensitive to the boundary conditions imposed, as boundaries strongly influence the direction and convergent nature of fluid flow towards wellbores. The observed flow weighted average well pressures are given as insets for the three boundary condition cases of FIG. 15. Sensitivity to the integrity of external boundaries is anticipated to heighten between multiple wellbores, e.g. well interference tests.

Of particular commercial interest is when the rectangular cell is a well block within a numerical reservoir simulation. The invention can then be used to describe well productivity (the relationship between pressure and production rate) for any complex well trajectory or wellbore cluster below the resolution of the simulation. The invention can be used for explicit computation of well properties or as feedback for an ongoing numerical simulation as a constraint on the pressure or total flux for the well block.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention. For example, potential and pressure have been used interchangeably in the development herein. The solutions are actually in terms of potential, with pressure being the commonly measured property. Potentials are routinely converted to pressures, as any skilled in the art would know, with the inclusion of gravitational forces. This is particularly relevant to pressure relationships for flow within a non-horizontal wellbore where gravitational head is an important contribution to the driving force for flow.

### Note on Special Limiting Cases (Wells Parallel to Coordinate Axes)

When the wells are oriented strictly parallel to one of the coordinate axes (horizontal and vertical wells), two of the direction cosines (α, β, γ) become zero. In such limiting cases, the generalized equations will present computing and coding challenges. By a proper grouping of the terms, and some algebraic simplifications, the relevant computations can be handled. Slow convergence rates often are the challenge in these limiting cases. Alternately, direct methods based upon components from published literature are available to address such simpler version of the general problem (Muskat, 1949; Babu and Odeh, 1989). For example, consider the following infinite series Bessel function solution to the Laplace Equation given by Muskat (1949, p. 208).

$$Pressure ∼ 2 {\sum }_{n = 1}^{∞} {K}_{o} ( \frac{π nr}{h} ) \cdot cos ( \frac{π nz}{h} ) cos ( \frac{π {nz}_{o}}{h} ) + ln ( \frac{4 h}{r} ) , \\ 0 < r < ∞ , 0 \leq z \leq h , 0 \leq {z}_{o} \leq h \qquad ( 48 )$$

This equation describes fluid flow due to a point sink/source at (r=0, z=zₒ) in a slab-like reservoir of thickness h, extending laterally to infinity, and with impermeable top and bottom boundaries (z=0, z=h). The convergence of the series in Equation (48) is extremely fast, and in most cases, only a few terms of the series are needed to achieve highly accurate results.

Integration with respect to zₒ, from z₁ to z₂, solves the problem of a partially penetrating vertical well. Problems of partially penetrating wells in rectangular box-shaped (bounded) reservoirs can be addressed by summing up all reflections of Kₒ across the sides of the rectangle. Change of variables, between (x, y, z), will solve problems of horizontal wells parallel to coordinate axes.

Next, to deal with small magnitudes of the variables (r/h) or (z/h), in Eq (48), the following expansions are available (Gradshteyn and Rhyzik, 2007, p. 939).

$${\sum }_{n = 1}^{∞} {K}_{o} ( π nX ) \cdot cos ( π nZ ) = \frac{1}{2} [ 0.5772 + ln ( \frac{X}{4} ) + \frac{1}{\sqrt{{X}^{2} + {Z}^{2}}} + {\sum }_{l = 1}^{∞} ( \begin{matrix}\frac{1}{\sqrt{{X}^{2} + {( 2 l - Z )}^{2}}} + \\ \frac{1}{\sqrt{{X}^{2} + {( 2 l + Z )}^{2}}} - \\ \frac{1}{l}\end{matrix} ) ] \qquad ( 49 )$$

For fast computations involving Equations (32) and (34) in the case of degenerate (limiting) versions of the general problem, the following formulas facilitate switching between the two types of series: Eq (48) in Kₒ, and the trigonometric series of Eqs (32) and (34). To separate variables α and β, use the integral (Gradshteyn and Rhyzik, 2007, p. 719)

$${\int }_{0}^{∞} {K}_{o} ( π α t ) \cdot cos ( π β t ) d t = \frac{1}{2 \sqrt{{α}^{2} + {β}^{2}}} . \qquad ( 50 )$$

In summing series that converge extremely slowly, we use the spectral representation of the Dirac Delta function, in conjunction with Eq (50), and subsequently achieve rapid convergence rates.

$$1 + 2 \cdot {\sum }_{m = 1}^{∞} cos ( \frac{π mt}{a} ) \cdot cos ( \frac{π mx}{a} ) = a \cdot {\sum }_{l = 0}^{∞} δ [ t - ( 2 al \pm x ) ] , \\ for 0 \leq x \leq a , 0 < t < ∞ \qquad ( 51 )$$

While elements leading to fast converging formulas for pressure computation in special case well orientations exist in the public domain, we incorporate the method of using these identities in tandem as a preferred embodiment of handling also the special cases as limiting simplified versions of this invention.

What is claimed is:

1. A rapid and highly accurate computer method for evaluation of pressure anywhere, including that observable at a wellbore radius, in a subterranean fluid reservoir with spatially invariant, anisotropic transport properties in response to specified injection or production through one or more wells, comprising:
a. Construction of a solution for potential through application of the Fundamental Theorem of Calculus and direct use of exact antiderivatives for accuracy and singularity handling in temporal and spatial integration of a point source Green's or Neumann function solution to the heat equation along a linear path in arbitrary three-dimensional orientation within a rectangular, box-shaped solution domain;
b. Simplification of the solution for potential using mathematical identities to a sum of exact, closed-form mathematical relations and a set of exponentially damped, rapidly converging series summations;
c. Evaluation of the pressure at any number of arbitrary observation points in space and time within the box-shaped cell through deployment of the simplified solution for potential on a computer.

2. The method cited in claim 1 to model productivity of wells of arbitrary trajectory using superposition and a piece-wise linear approximation to the well path.

3. The method in claim 1 within a system to model heterogeneous reservoirs using boundary integral methods to impose continuity of pressure and flux across locally homogeneous, anisotropic cells comprising the mathematical description of the heterogeneous reservoir.

4. The method in claim 1 which confines computations locally to only those cells intersected by wellbores within a system to relate the observable wellbore pressure and the properties on a grid in numerical simulation of fluid flow.

5. The method in claim 1 applied to two-dimensional problems, as simplified versions of 3D cases in which the spatial integration is along an arbitrarily-oriented line, suitable for modeling a fractured well, complex fracture sets, or a horizontal or inclined well in a sufficiently thin reservoir.

6. A rapid and highly accurate computer method for evaluation of pressure anywhere, including that observable at the wellbore radius to characterize well productivity, in a subterranean fluid reservoir with spatially invariant, anisotropic transport properties in response to specified injection or production through one or more wells that incorporates coupling of pressure at the wellbore radius to internal wellbore pressure gradients, comprising:
a. Construction of a solution for potential through direct application of the Fundamental Theorem of Calculus and direct use of exact antiderivatives in temporal and spatial integration of a point source Green's or Neumann function solution to the heat equation along a linear path in arbitrary three-dimensional orientation within a rectangular, box-shaped solution domain;
b. Simplification of the solution for potential using mathematical identities to a sum of closed-form mathematical relations and a set of exponentially damped, rapidly converging series summations;
c. Evaluation of the pressure at two or more selected observation points corresponding to well radii along the wellpath through deployment of the simplified solution for potential on a computer;
d. Adjustment of well flux magnitudes between wellpath observation points to honor a constitutive relationship describing the pressure response to volumetric flow in the interior of the wellbore;
e. Assessment of the pressure at any number of arbitrary observation points in space and time within the box-shaped cell, including that observable at the wellbore radius to characterize well productivity.

7. The method cited in claim 6 to model productivity of wells of arbitrary trajectory using superposition and a piece-wise linear approximation to the well path.

8. The method in claim 6 within a system to model heterogeneous reservoirs using boundary integral methods to impose continuity of pressure and flux across locally homogeneous, anisotropic cells comprising the mathematical description of the heterogeneous reservoir.

9. The method in claim 6 which confines computations locally to only those cells intersected by wellbores within a system to relate the observable wellbore pressure and the properties on a grid in numerical simulation of fluid flow.

10. The method in claim 6 applied to two-dimensional problems, as simplified versions of 3D cases in which the spatial integration is along an arbitrarily-oriented line, suitable for modeling a fractured well, complex fracture sets, or a horizontal or inclined well in a sufficiently thin reservoir.

11. A rapid and highly accurate computer method for evaluation of representative wellbore pressure, in a subterranean fluid reservoir with spatially invariant, anisotropic transport properties in response to specified injection or production through one or more wells that provides a means for feedback control for those cells intersected by wellbores within a numerical reservoir simulator, comprising:
a. Construction of a solution for potential through direct application of the Fundamental Theorem of Calculus and direct use of exact antiderivatives in temporal and spatial integration of a point source Green's or Neumann function solution to the heat equation along one or more linear well path segments in arbitrary three-dimensional orientation within a rectangular, box-shaped solution domain;
b. Simplification of the solution for potential using mathematical identities to a sum of exact, closed-form mathematical relations and a set of exponentially damped, rapidly converging series summations;
c. Evaluation of a representative wellbore pressure through deployment of the simplified solution for potential on a computer;
d. Use of the computed wellbore pressure within a numerical simulation of fluid flow in a subterranean fluid reservoir, including use as a feedback mechanism to regulate flux for those cells intersected by wellbores.

12. The method in claim 11 in which the flux distribution along two or more segments honors a constitutive relationship describing the pressure drop response to volumetric flow inside the well.

13. The method in claim 11 applied to two-dimensional problems, as simplified versions of 3D cases in which the integration is along an arbitrarily-oriented line, suitable for modeling a fractured well, complex fracture sets, or a horizontal or inclined well in a sufficiently thin reservoir.
